(19) United States
(12) Patent Application Publication
(10) Pub. No.: US 2024/0291981 A1
(43) Pub. Date: Aug. 29, 2024

(54) AN APPARATUS, A METHOD AND A COMPUTER PROGRAM FOR VIDEO CODING AND DECODING

(71) Applicant: Nokia Technologies Oy, Espoo (FI)

(72) Inventors: Alireza ZARE, Tampere (FI); Alireza AMINLOU, Tampere (FI); Miska Matias HANNUKSELA, Tampere (FI)

(21) Appl. No.: 18/693,380

(22) PCT Filed: Aug. 31, 2022
(86) PCT No.: PCT/FI2022/050564

§ 371 Date: Mar. 19, 2024

(30) Foreign Application Priority Data
Sep. 23, 2021 (FI) 20215997

(51) Int. Cl. H04N 19/117; H04N 19/119; H04N 19/174

(52) U.S. Cl. CPC H04N 19/117; H04N 19/119; H04N 19/174

(57) ABSTRACT

A method comprising: dividing pictures of one or more input picture sequences into a plurality of subpictures (1000); encoding each of the subpictures into a plurality of subpicture versions having different quality and/or resolution (1002); partitioning the plurality of subpicture versions into one or more subpicture groups (1004); and allocating a range of adaptive loop filter parameter set identifiers coefficients for each of said subpicture groups (1006).

### TECHNICAL FIELD

The present invention relates to an apparatus, a method and a computer program for video coding and decoding.

### BACKGROUND

Recently, the development of various multimedia streaming applications, especially 360-degree video or virtual reality (VR) applications, has advanced with big steps. In viewport-adaptive streaming (VAS), the bitrate is aimed to be reduced e.g. such that the primary viewport (i.e., the current viewing orientation) is transmitted at the best quality/resolution, while the remaining of 360-degree video is transmitted at a lower quality/resolution. When the viewing orientation changes, e.g. when the user turns his/her head when viewing the content with a head-mounted display, another version of the content needs to be streamed, matching the new viewing orientation.

There are several alternatives to deliver the viewport-dependent omnidirectional video. It can be delivered, for example, as equal-resolution bitstreams with motion-constrained tile sets (MCTSs) or with independent subpictures. What is common to these approaches is that there are two or more at least partly independently encoded bitstreams, which need to be aggregated into a single picture representation upon rendering.

Compared to prior video coding standards, Versatile Video Coding (H.266/VVC a.k.a. VVC) introduces more complexity in filtering the image data. The limitations of allocating adaptive loop filtering (ALF) coefficients may cause problems, for example in VAS upon aggregation, if the two or more bitstreams are not encoded in a coordinated manner.

### SUMMARY

Now, an improved method and technical equipment implementing the method has been invented, by which the above problems are alleviated. Various aspects include methods, apparatuses and a computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

An apparatus according to a first aspect comprises: means for dividing pictures of one or more input picture sequences into a plurality of subpictures; means for encoding each of the subpictures into a plurality of subpicture versions having different quality and/or resolution; means for partitioning the plurality of subpicture versions into one or more subpicture groups; and means for allocating a range of adaptive loop filter parameter set identifiers for each of said subpicture groups.

According to an embodiment, the apparatus comprises: means for partitioning the plurality of subpicture versions into one subpicture group; and means for dividing said range of adaptive loop filter parameter set identifiers for each subpicture version such that each subpicture version has its own unique range of adaptive loop filter parameter set identifiers.

According to an embodiment, the apparatus comprises: means for partitioning the subpicture versions into a corresponding number of subpicture groups, each consisting of one subpicture version; and means for allocating each subpicture version with its own unique range of adaptive loop filter parameter set identifiers.

According to an embodiment, the apparatus comprises: means for partitioning a plurality of subpicture versions into at least one subpicture group consisting of a plurality of subpicture versions; and means for allocating each subpicture group with its own unique range of adaptive loop filter parameter set identifiers.

According to an embodiment, the apparatus comprises: means for determining a total number of allocated adaptive loop filter parameter set identifiers for all subpicture groups such that the number of adaptive loop filter parameter set identifiers in any bitstream merged from all subpicture groups is less than or equal to the maximum number of adaptive loop filter parameter set identifiers.

According to an embodiment, the apparatus comprises: means for determining one or more subpicture groups obtaining an improvement on the coding rate distortion (RD) performance via usage of adaptive loop filter parameter set identifiers; and means for determining a higher number of adaptive loop filter parameter set identifiers to be allocated to said one or more subpicture groups.

According to an embodiment, the apparatus comprises: means for grouping co-located subpictures versions across different quality versions into one subpicture group.

According to an embodiment, the apparatus comprises: means for allocating one or more same adaptive loop filter parameter set identifiers to a plurality of subpicture groups, wherein subpicture groups with the same adaptive loop filter parameter set identifiers values but different adaptive loop filter parameter set content are configured not to be merged into a same bitstream in response to occurrence of one or more predetermined merging constraint.

According to an embodiment, said merging constraint comprise one or more of the following:
a maximum number of spherically adjacent subpicture groups that can be covered by high-resolution and/or high-quality subpicture groups
a predetermined viewing orientation range.

According to an embodiment, the apparatus comprises: means for providing a control signal to control more than one video encoder or more than one video encoder instance, the control signal comprising said range of adaptive loop filter parameter set identifiers that are allowed to be used in encoding.

According to an embodiment, the apparatus comprises: means for formatting the control signal as one or more optional media parameters

According to an embodiment, the control signal is, or is a part of, a configuration file defining the encoding settings used by an encoder.

According to an embodiment, the control signal is, or is a part of, an application programming interface used to control an encoder.

A method according to a second aspect comprises: dividing pictures of one or more input picture sequences into a plurality of subpictures; encoding each of the subpictures into a plurality of subpicture versions having different quality and/or resolution; partitioning the plurality of subpicture versions into one or more subpicture groups; and allocating a range of adaptive loop filter parameter set identifiers for each of said subpicture groups.

An apparatus according to a third aspect comprises at least one processor and at least one memory, said at least one memory stored with computer program code thereon, the at least one memory and the computer program code configured to, with the at least one processor, cause the apparatus at least to perform: divide pictures of one or more input picture sequences into a plurality of subpictures; encode each of the subpictures into a plurality of subpicture versions having different quality and/or resolution; partition the plurality of subpicture versions into one or more subpicture groups; and allocate a range of adaptive loop filter parameter set identifiers for each of said subpicture groups.

The further aspects relate to apparatuses and computer readable storage media stored with code thereon, which are arranged to carry out the above methods and one or more of the embodiments related thereto.

### BRIEF DESCRIPTION OF THE DRAWINGS

For better understanding of the present invention, reference will now be made by way of example to the accompanying drawings in which:

FIG. 1 shows schematically an electronic device employing embodiments of the invention;

FIG. 2 shows schematically a user equipment suitable for employing embodiments of the invention;

FIGS. 3a and 3b show schematically an encoder and a decoder suitable for implementing embodiments of the invention;

FIGS. 4a-4d show examples of partitioning a picture into subpictures, slices, and tiles according to H.266/VVC;

FIG. 5 shows an example of MPEG Omnidirectional Media Format (OMAF) concept;

FIGS. 6a and 6b show two alternative methods for packing 360-degree video content into 2D packed pictures for encoding;

FIG. 7 shows the process of forming a monoscopic equirectangular panorama;

FIG. 8 shows an example of delivery of equal-resolution HEVC bitstreams with motion-constrained tile sets;

FIGS. 9a and 9b show schematically a cross-component adaptive loop filtering arrangement and the diamond-shaped filter related thereto;

FIG. 10 shows a flow chart of an encoding method according to an embodiment of the invention;

FIGS. 11a-11f show some examples of assigning subpicture versions into subpicture groups and the number of ALF APS identifiers allocated for subpicture versions and/or subpicture groups;

FIG. 12 shows an example of packing different subpicture quality versions of each subpicture group together and coding using a single encoder instance according to an embodiment;

FIGS. 13a and 13b show an example of performing the ALF APS identifier allocation according to the impact of the use of ALF APS(s) on the RD performance of subpicture versions according to an embodiment;

FIG. 14 shows an example for 6K effective ERP resolution with VVC Level 5, 5.1 or 5.2 decoding capability;

FIG. 15 shows an example of a bitstream merged from subpictures selected from the example of FIG. 14;

FIG. 16 shows an example of stereoscopic mixed-quality ERP and a merged bitstream for decoding;

FIG. 17 shows an example of packing the subpicture versions into a single picture and coding in different versions using a single-rate encoder according to an embodiment;

FIG. 18 shows an example of encoding each subpicture versions using a multi-rate encoder according to an embodiment;

FIG. 19 shows an example of a cubemap projection partitioned into subpictures and ALF APS subpicture groups according to an embodiment;

FIG. 20 shows a sequence-wise and average BD-rate gain of allocation plan shown in FIG. 19, when compared with ALF APS being disabled; and

FIG. 21 shows a schematic diagram of an example multimedia communication system within which various embodiments may be implemented.

### DETAILED DESCRIPTION OF SOME EXAMPLE EMBODIMENTS

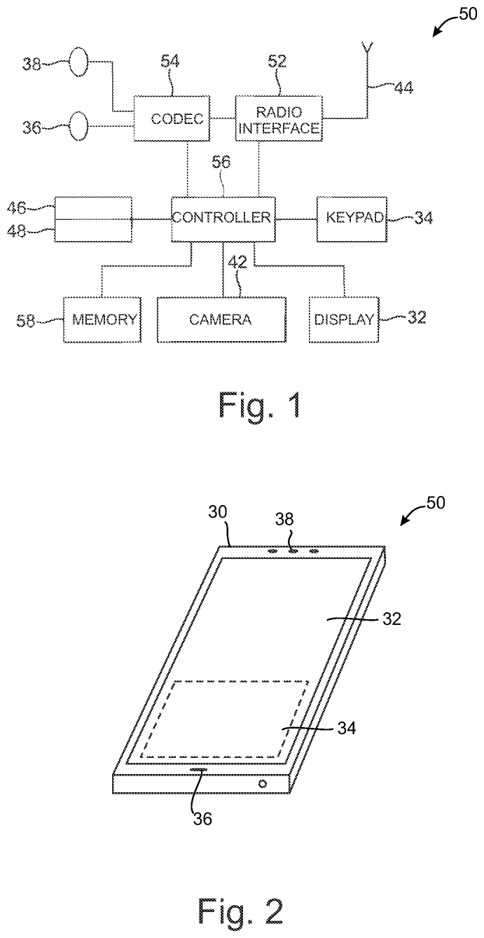

The following describes in further detail suitable apparatus and possible mechanisms for allocating filter coefficients. In this regard reference is first made to FIGS. 1 and 2, where FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (or in other embodiments of the invention the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

A video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically encoder discards some information in the original video sequence in order to represent the video in a more compact form (that is, at lower bitrate).

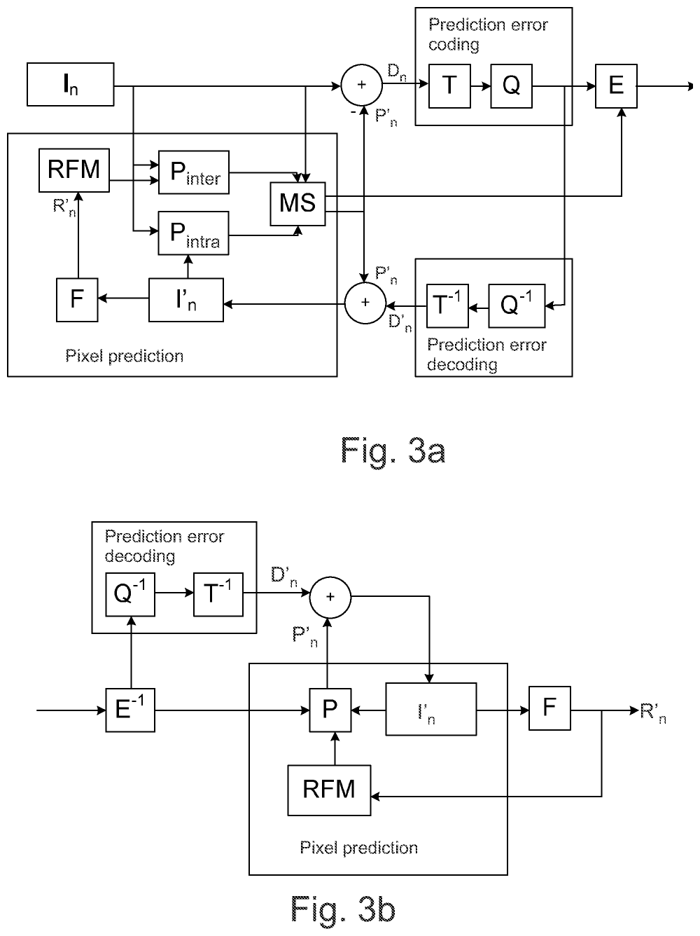

FIGS. 3a and 3b show an encoder and decoder for encoding and decoding the 2D pictures. A video codec consists of an encoder that transforms an input video into a compressed representation suited for storage/transmission and a decoder that can uncompress the compressed video representation back into a viewable form. Typically, the encoder discards and/or loses some information in the original video sequence in order to represent the video in a more compact form (that is, at lower bitrate).

An example of an encoding process is illustrated in FIG. 3a. FIG. 3a illustrates an image to be encoded (In); a predicted representation of an image block (P′n); a prediction error signal (Dn); a reconstructed prediction error signal (D′n); a preliminary reconstructed image (I′n); a final reconstructed image (R′n); a transform (T) and inverse transform (T-1); a quantization (Q) and inverse quantization (Q-1); entropy encoding (E); a reference frame memory (RFM); inter prediction (Pinter); intra prediction (Pintra); mode selection (MS) and filtering (F).

An example of a decoding process is illustrated in FIG. 3b. FIG. 3b illustrates a predicted representation of an image block (P′n); a reconstructed prediction error signal (D′n); a preliminary reconstructed image (I′n); a final reconstructed image (R′n); an inverse transform (T-1); an inverse quantization (Q-1); an entropy decoding (E-1); a reference frame memory (RFM); a prediction (either inter or intra) (P); and filtering (F).

Thus, the decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. The filtering may for example include one more of the following: deblocking, sample adaptive offset (SAO), and/or adaptive loop filtering (ALF).

Many hybrid video encoders, such as H.264/AVC encoders, High Efficiency Video Coding (H.265/HEVC a.k.a. HEVC) and Versatile Video Coding (H.266/VVC a.k.a. VVC) encoders, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). Video codecs may also provide a transform skip mode, which the encoders may choose to use. In the transform skip mode, the prediction error is coded in a sample domain, for example by deriving a sample-wise difference value relative to certain adjacent samples and coding the sample-wise difference value with an entropy coder.

In temporal prediction, the sources of prediction are previously decoded pictures (a.k.a. reference pictures). In intra block copy (IBC; a.k.a. intra-block-copy prediction), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In many video codecs, including H.264/AVC, HEVC and VVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or picture).

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC.

Some key definitions, bitstream and coding structures, and concepts of VVC, especially regarding the picture partitioning, are described in this section as an example of a platform, where the embodiments may be implemented. Some of the key definitions, bitstream and coding structures, and concepts of H.266/VVC are the same as in H.264/AVC and. The embodiments are not limited to H.266/VVC, but rather the description is given for one possible basis on top of which the aspects of the invention and the related embodiments may be partly or fully realized.

An elementary unit for the input to an encoder and the output of a decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YCgCo),
Green, Blue and Red (GBR, also known as RGB),
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of HEVC or alike. A component may be defined as an array or single sample from one of the three sample arrays (luma and two chroma) that compose a picture e.g. in 4:2:0, 4:2:2 or 4:4:4 chroma format or the array or a single sample of the array that compose a picture in monochrome format.

A picture may be defined to be either frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats (a.k.a color formats) may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Partitioning may be defined as a division of a set into subsets such that each element of the set is in exactly one of the subsets.

In the following, partitioning a picture into subpictures, slices, and tiles according to H.266/VVC is described more in detail.

A picture is divided into one or more tile rows and one or more tile columns. A tile is a sequence of coding tree units (CTU) that covers a rectangular region of a picture. The CTUs in a tile are scanned in raster scan order within that tile.

A slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture may be defined as a rectangular region of one or more slices within a picture, wherein the one or more slices are complete. Thus, a subpicture consists of one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices.

One or both of the following conditions shall be fulfilled for each subpicture and tile:
All CTUs in a subpicture belong to the same tile.
All CTUs in a tile belong to the same subpicture.

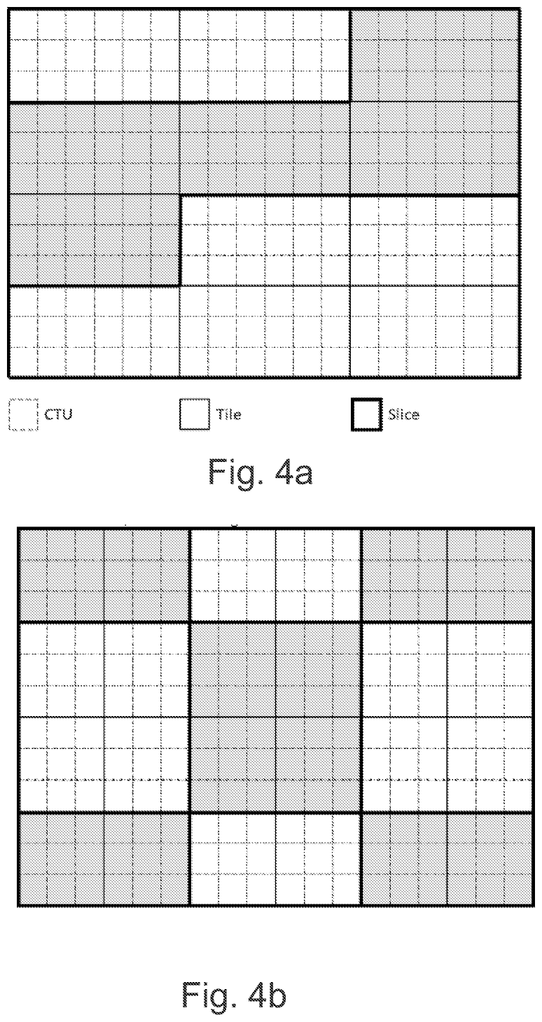

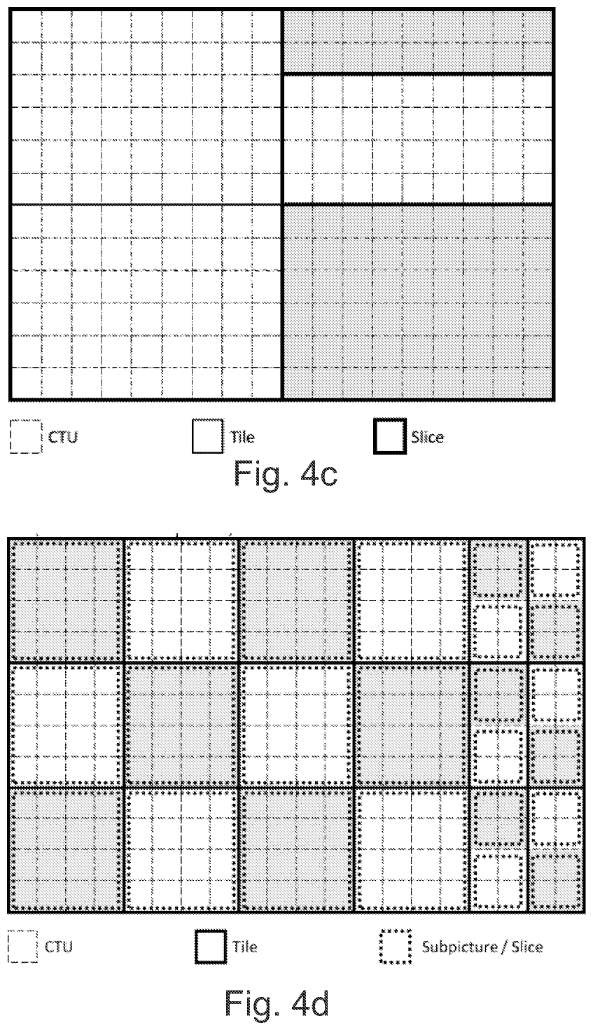

FIG. 4a shows an example of raster-scan slice partitioning of a picture, where the picture is divided into 12 tiles and 3 raster-scan slices.

FIG. 4b shows an example of rectangular slice partitioning of a picture, where the picture is divided into 24 tiles (6 tile columns and 4 tile rows) and 9 rectangular slices.

FIG. 4c shows an example of a picture partitioned into tiles and rectangular slices, where the picture is divided into 4 tiles (2 tile columns and 2 tile rows) and 4 rectangular slices.

FIG. 4d an example of subpicture partitioning of a picture, where a picture is partitioned into 18 tiles, 12 tiles on the left-hand side each covering one slice of 4 by 4 CTUs and 6 tiles on the right-hand side each covering 2 vertically-stacked slices of 2 by 2 CTUs, altogether resulting in 24 slices and 24 subpictures of varying dimensions (each slice is a subpicture).

The samples are processed in units of coding tree blocks (CTB). The array size for each luma CTB in both width and height is CtbSizeY in units of samples. The width and height of the array for each chroma CTB are CtbWidthC and CtbHeightC, respectively, in units of samples.

Each CTB is assigned a partition signalling to identify the block sizes for intra or inter prediction and for transform coding. The partitioning is a recursive quadtree partitioning. The root of the quadtree is associated with the CTB. The quadtree is split until a leaf is reached, which is referred to as the quadtree leaf. When the component width is not an integer number of the CTB size, the CTBs at the right component boundary are incomplete. When the component height is not an integer multiple of the CTB size, the CTBs at the bottom component boundary are incomplete.

The coding block is the root node of two trees, the prediction tree and the transform tree. The prediction tree specifies the position and size of prediction blocks. The transform tree specifies the position and size of transform blocks. The splitting information for luma and chroma is identical for the prediction tree and may or may not be identical for the transform tree.

The blocks and associated syntax structures are grouped into “unit” structures as follows:
One transform block (monochrome picture) or three transform blocks (luma and chroma components of a picture in 4:2:0, 4:2:2 or 4:4:4 colour format) and the associated transform syntax structures units are associated with a transform unit.
One coding block (monochrome picture) or three coding blocks (luma and chroma), the associated coding syntax structures and the associated transform units are associated with a coding unit.
One CTB (monochrome picture) or three CTBs (luma and chroma), the associated coding tree syntax structures and the associated coding units are associated with a CTU.

In VCC, the following divisions of processing elements form spatial or component-wise partitioning:
The division of each picture into components
The division of each component into CTBs
The division of each picture into subpictures
The division of each picture into tile columns
The division of each picture into tile rows
The division of each tile column into tiles
The division of each tile row into tiles
The division of each tile into CTUs
The division of each picture into slices
The division of each subpicture into slices
The division of each slice into CTUs
The division of each CTU into CTBs
The division of each CTB into coding blocks, except that the CTBs are incomplete at the right component boundary when the component width is not an integer multiple of the CTB size and the CTBs are incomplete at the bottom component boundary when the component height is not an integer multiple of the CTB size
The division of each CTU into coding units, except that the CTUs are incomplete at the right picture boundary when the picture width in luma samples is not an integer multiple of the luma CTB size and the CTUs are incomplete at the bottom picture boundary when the picture height in luma samples is not an integer multiple of the luma CTB size
The division of each coding unit into transform units
The division of each coding unit into coding blocks
The division of each coding block into transform blocks
The division of each transform unit into transform blocks

For each of the above-listed divisions of an entity A into entities B being a partitioning, it is requirement of bitstream conformance that the union of the entities B resulted from the partitioning of the entity A shall cover exactly the entity A with no overlaps, no gaps, and no additions.

For example, corresponding to the division of each picture into subpictures being a partitioning, it is requirement of bitstream conformance that the union of the subpictures resulted from the partitioning of a picture shall cover exactly the picture, with no overlaps, no gaps, and no CTUs in the union that are outside the picture.

In video coding, an isolated region may be defined as a picture region that is allowed to depend only on the corresponding isolated region in reference pictures and does not depend on any other picture regions in the current picture or in the reference pictures. The corresponding isolated region in reference pictures may be for example the picture region that collocates with the isolated region in a current picture. A coded isolated region may be decoded without the presence of any picture regions of the same coded picture.

Pictures, whose isolated regions are predicted from each other, may be grouped into an isolated-region picture group. An isolated region can be inter-predicted from the corresponding isolated region in other pictures within the same isolated-region picture group, whereas inter prediction from other isolated regions or outside the isolated-region picture group may be disallowed.

A leftover region (a.k.a. non-isolated region) may be defined as a picture region that is not constrained like an isolated region and thus may be predicted from picture regions that do not correspond to the leftover region itself in the current picture or reference pictures.

In VVC, partitioning of a picture to subpictures may be indicated in and/or decoded from an SPS (Sequence Parameter Set); in other words, the subpicture layout may be indicated in and/or decoded from an SPS. The SPS syntax may indicate the partitioning of a picture to subpictures e.g. by providing for each subpicture syntax elements indicative of: the x and y coordinates of the top-left corner of the subpicture, the width of the subpicture, and the height of the subpicture, in coding tree units (CTU). Thus, a subpicture layout indicates the positions, widths, and heights of subpictures within a picture but does not assign subpictures or subpicture sequences of any particular identifiers to the subpicture layout.

In VVC, one or more of the following properties may be indicated (e.g. by an encoder) or decoded (e.g. by a decoder) or inferred (e.g. by an encoder and/or a decoder) for the subpictures collectively or per each subpicture individually: i) whether or not a subpicture is treated as a picture in the decoding process; in some cases, this property excludes in-loop filtering operations, which may be separately indicated/decoded/inferred; ii) whether or not in-loop filtering operations are performed across the subpicture boundaries. Property i) may alternatively be expressed as whether or not subpicture boundaries are treated like picture boundaries. Treating subpicture boundaries like picture boundaries comprises saturating any prediction references to sample locations outside the subpicture to be within the boundaries of the subpicture. An independent subpicture may be defined as a subpicture with subpicture boundaries treated like picture boundaries and with in-loop filtering disabled across subpicture boundaries. An independent subpicture is an example of an isolated region.

A motion-constrained tile set (MCTS) is a set of tiles such that the inter prediction process is constrained in encoding such that no sample value outside the MCTS, and no sample value at a fractional sample position that is derived using one or more sample values outside the motion-constrained tile set, is used for inter prediction of any sample within the motion-constrained tile set. Additionally, the encoding of an MCTS is constrained in a manner that no parameter prediction takes inputs from blocks outside the MCTS. For example, the encoding of an MCTS is constrained in a manner that motion vector candidates are not derived from blocks outside the MCTS. In HEVC, this may be enforced by turning off temporal motion vector prediction of HEVC, or by disallowing the encoder to use the temporal motion vector prediction (TMVP) candidate or any motion vector prediction candidate following the TMVP candidate in a motion vector candidate list for prediction units located directly left of the right tile boundary of the MCTS except the last one at the bottom right of the MCTS.

In general, an MCTS may be defined to be a tile set that is independent of any sample values and coded data, such as motion vectors, that are outside the MCTS. An MCTS sequence may be defined as a sequence of respective MCTSs in one or more coded video sequences or alike. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets. An MCTS is an example of an isolated region.

A subpicture sequence may be defined as a sequence of collocated subpictures in a sequence of coded pictures. Alternatively, a subpicture sequence may be defined as a sequence of subpictures having the same subpicture identifier value. An independent subpicture sequence may be defined as a subpicture sequence in which all subpictures are independent subpictures. Depending on the context, it may be understood that a subpicture sequence is a coded subpicture sequence or an uncompressed or decoded subpicture sequence. A subpicture version may be defined as a coded subpicture sequence.

It is possible to encode independent subpicture sequences in two ways: i) An encoder may encode pictures that comprise multiple independent subpictures. An independent subpicture sequence may be extracted from the encoded bitstream containing multiple subpicture sequences. ii) Uncompressed video may be split into multiple uncompressed subpicture sequences. An uncompressed subpicture sequence may be provided as input to an encoder that generates a bitstream comprising coded pictures, each having a single subpicture. Each uncompressed subpicture sequence may be encoded separately into separate bitstreams by the same encoder or by different encoders. It is also possible to combine approaches i) and ii) into approach iii) as follows: Uncompressed video may be split into multiple uncompressed sequences covering subpicture groups. An uncompressed sequence of subpicture groups may be provided as input to an encoder that generates a bitstream comprising coded pictures, each having a group of subpictures. Each uncompressed sequence of subpicture groups may be encoded separately into separate bitstreams by the same encoder or by different encoders. Approaches ii) and iii) may be referred to as distributed subpicture encoding.

Distributed subpicture encoding may provide multiple benefits including, but not limited to, the following:
It is envisioned that there may be encoder implementations that do not provide support for multiple subpictures at all or do not provide support for multiple subpictures whose boundaries are treated like picture boundaries.
Parallel encoding, e.g. in separate processing cores, can be more easily achieved when encoding the video sources with separate encoder instances compared to encoding with a single encoder instance with multiple subpictures. When running multiple encoder instances, the encoder implementation does not need to include handling of separate processes or threads per each subpicture.

Distributed subpicture encoding may require encoding of different bitstreams to be coordinated in a manner that the bitstreams can be merged as subpicture sequences into a single destination bitstream. For example, it may be necessary to apply the same inter prediction hierarchies in the bitstreams and/or the time-aligned pictures in the bitstreams may be required to use the same reference picture sets.

A syntax element may be defined as an element of data represented in the bitstream. A syntax structure may be defined as zero or more syntax elements present together in the bitstream in a specified order.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. The NAL unit header indicates the type of the NAL unit among other things.

NAL units can be categorized into Video Coding Layer (VCL) NAL units and non-VCL NAL units. VCL NAL units are typically coded slice NAL units.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

Some types of parameter sets are briefly described in the following but it needs to be understood that other types of parameter sets may exist and that embodiments may be applied but are not limited to the described types of parameter sets. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on picture basis. In VVC, an Adaptation Parameter Set (APS) may comprise parameters for decoding processes of different types, such as adaptive loop filtering or luma mapping with chroma scaling.

A parameter set may be activated when it is referenced e.g., through its identifier. For example, a header of an image segment, such as a slice header, may contain an identifier of the PPS that is activated for decoding the coded picture containing the image segment. A PPS may contain an identifier of the SPS that is activated, when the PPS is activated. An activation of a parameter set of a particular type may cause the deactivation of the previously active parameter set of the same type. Instead of explicitly activating and deactivating parameter sets, the syntax element values of a parameter set may be used in the (de)coding process when the parameter set is referenced e.g. through its identifier, similarly as explained above regarding parameter set activation.

An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g. ALF, LMCS, or scaling list) and an identifier. In other words, different types of APSs have their own identifier value ranges.

Instead of or in addition to parameter sets at different hierarchy levels (e.g., sequence and picture), video coding formats may include header syntax structures, such as a sequence header or a picture header. A sequence header may precede any other data of the coded video sequence in the bitstream order. A picture header may precede any coded video data for the picture in the bitstream order.

In VVC, a picture header (PH) may be defined as a syntax structure containing syntax elements that apply to all slices of a coded picture. In other words, contains information that is common for all slices of the coded picture associated with the PH. A picture header syntax structure is specified as an RBSP and is contained in a NAL unit.

A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and which is the last NAL unit of the bitstream.

The phrase along the bitstream (e.g. indicating along the bitstream) or along a coded unit of a bitstream (e.g. indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

A coded video sequence (CVS) may be defined as such a sequence of coded pictures in decoding order that is independently decodable and is followed by another coded video sequence or the end of the bitstream. A coded video sequence may additionally or alternatively be specified to end, when a specific NAL unit, which may be referred to as an end of sequence (EOS) NAL unit, appears in the bitstream.

Media coding standards may specify “profiles” and “levels.” A profile may be defined as a subset of algorithmic features of the standard (of the encoding algorithm or the equivalent decoding algorithm). In another definition, a profile is a specified subset of the syntax of the standard (and hence implies that the encoder may only use features that result into a bitstream conforming to that specified subset and the decoder may only support features that are enabled by that specified subset).

A level may be defined as a set of limits to the coding parameters that impose a set of constraints in decoder resource consumption. In another definition, a level is a defined set of constraints on the values that may be taken by the syntax elements and variables of the standard. These constraints may be simple limits on values. Alternatively, or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

Video encoders may utilize Lagrangian cost functions to find coding modes, e.g. the desired block partitioning and/or motion vectors. This kind of cost function uses a weighting factor λ to tie together the (exact or estimated) image distortion due to lossy coding methods and the (exact or estimated) amount of information that is required to represent the pixel value in an image area:

$$C = D + λ R \qquad ( Eq . 1 )$$

where C is the Lagrangian cost to be minimized, D is the image distortion (e.g Mean Squared Error), e.g. with the block partitioning and/or motion vectors considered, and R is the number of bits needed to represent the required data to reconstruct the image block in the decoder (including the amount of data to represent the block partitioning and/or the motion vectors). A Lagrangian cost may be a way to quantify rate distortion (RD) performance. Using a Lagrangian cost in coding mode selection may be referred to as rate-distortion optimization or rate-distortion-optimized encoding.

Virtual reality is a rapidly developing area of technology in which image or video content, sometimes accompanied by audio, is provided to a user device such as a user headset (a.k.a. head-mounted display, HMD). As is known, the user device may be provided with a live or stored feed from a content source, the feed representing a virtual space for immersive output through the user device.

Terms 360-degree video or virtual reality (VR) video may sometimes be used interchangeably. They may generally refer to video content that provides such a large field of view that only a part of the video is displayed at a single point of time in typical displaying arrangements. For example, VR video may be viewed on a head-mounted display (HMD) that may be capable of displaying e.g. about 100-degree Field of view. The spatial subset of the VR video content to be displayed may be selected based on the orientation of the HMD. In another example, a typical flat-panel viewing environment is assumed, wherein e.g. up to 40-degree Field-of-view may be displayed. When displaying wide-FOV content (e.g. fisheye) on such a display, it may be preferred to display a spatial subset rather than the entire picture.

A coordinate system suitable for 360-degree images and/or video may be defined as follows. The coordinate system consists of a unit sphere and three coordinate axes, namely the X (back-to-front) axis, the Y (lateral, side-to-side) axis, and the Z (vertical, up) axis, where the three axes cross at the centre of the sphere. The location of a point on the sphere is identified by a pair of sphere coordinates azimuth (ϕ) and elevation (θ), where the azimuth may represent rotation around the Z-axis and the elevation may represent rotation around the Y-axis or the X-axis. The value range of azimuth may be defined to be −180.0, inclusive, to 180.0, exclusive, degrees. The value range of elevation may be defined to be −90.0 to 90.0, inclusive, degrees.

MPEG Omnidirectional Media Format (ISO/IEC 23090-2) is a virtual reality (VR) system standard. OMAF defines a media format (comprising both file format derived from ISOBMFF and streaming formats for DASH and MPEG Media Transport). OMAF supports 360° video, images, and audio, as well as the associated timed text and facilitates three degrees of freedom (3DoF) content consumption, meaning that a viewport can be selected with any azimuth and elevation range and tilt angle that are covered by the omnidirectional content but the content is not adapted to any translational changes of the viewing position.

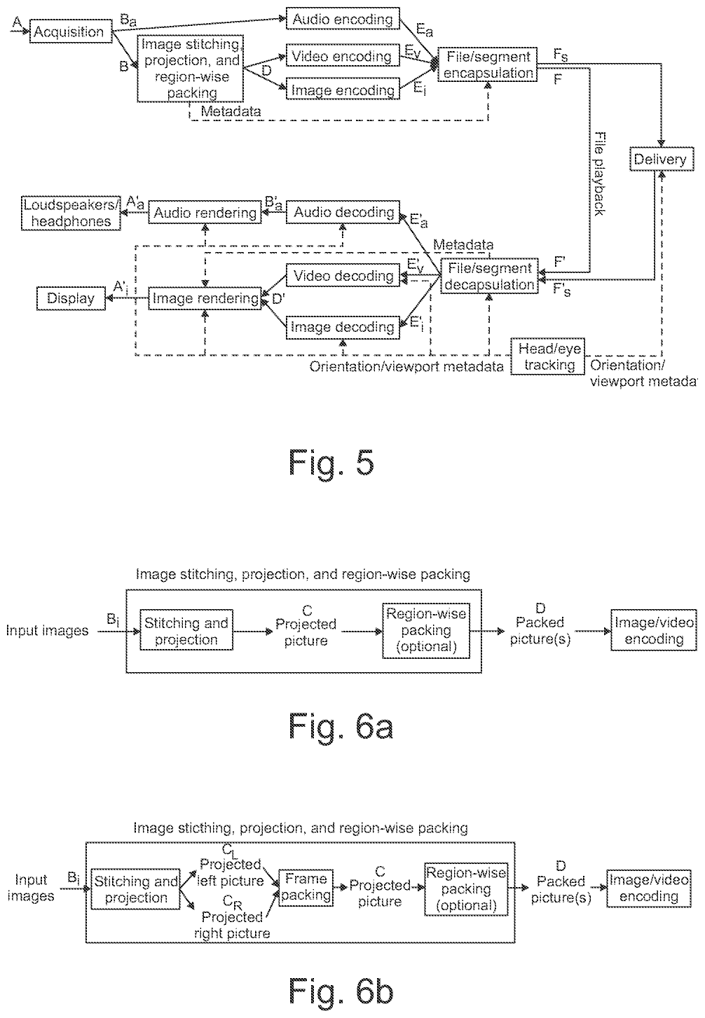

MPEG Omnidirectional Media Format (OMAF) is described in the following by referring to FIG. 5. A real-world audio-visual scene (A) is captured by audio sensors as well as a set of cameras or a camera device with multiple lenses and sensors. The acquisition results in a set of digital image/video (Bi) and audio (Ba) signals. The cameras/lenses typically cover all directions around the center point of the camera set or camera device, thus the name of 360-degree video.

Audio can be captured using many different microphone configurations and stored as several different content formats, including channel-based signals, static or dynamic (i.e. moving through the 3D scene) object signals, and scene-based signals (e.g., Higher Order Ambisonics). The channel-based signals typically conform to one of the loudspeaker layouts defined in CICP. In an omnidirectional media application, the loudspeaker layout signals of the rendered immersive audio program are binaraulized for presentation via headphones.

The images (Bi) of the same time instance are stitched, projected, and mapped onto a packed picture (D).

For monoscopic 360-degree video, the input images of one time instance are stitched to generate a projected picture representing one view. The breakdown of image stitching, projection, and region-wise packing process for monoscopic content is illustrated with FIG. 6a and described as follows. Input images (Bi) are stitched and projected onto a three-dimensional projection structure that may for example be a unit sphere. The projection structure may be considered to comprise one or more surfaces, such as plane(s) or part(s) thereof. A projection structure may be defined as three-dimensional structure consisting of one or more surface(s) on which the captured VR image/video content is projected, and from which a respective projected picture can be formed. The image data on the projection structure is further arranged onto a two-dimensional projected picture (C). The term projection may be defined as a process by which a set of input images are projected onto a projected frame. There may be a pre-defined set of representation formats of the projected picture, including for example an equirectangular projection (ERP) format and a cube map projection (CMP) format. It may be considered that the projected picture covers the entire sphere.

Optionally, region-wise packing is then applied to map the projected picture onto a packed picture. If the region-wise packing is not applied, the packed picture is identical to the projected picture, and this picture is given as input to image/video encoding. Otherwise, regions of the projected picture are mapped onto a packed picture (D) by indicating the location, shape, and size of each region in the packed picture, and the packed picture (D) is given as input to image/video encoding. The term region-wise packing may be defined as a process by which a projected picture is mapped to a packed picture. The term packed picture may be defined as a picture that results from region-wise packing of a projected picture.

In the case of stereoscopic 360-degree video, the input images of one time instance are stitched to generate a projected picture representing two views, one for each eye. Both views can be mapped onto the same packed picture, as described below in relation to the FIG. 6b, and encoded by a traditional 2D video encoder. Alternatively, each view of the projected picture can be mapped to its own packed picture, in which case the image stitching, projection, and region-wise packing is like described above with the FIG. 6a. A sequence of packed pictures of either the left view or the right view can be independently coded or, when using a multiview video encoder, predicted from the other view.

The breakdown of image stitching, projection, and region-wise packing process for stereoscopic content where both views are mapped onto the same packed picture is illustrated with the FIG. 6b and described as follows. Input images (Bi) are stitched and projected onto two three-dimensional projection structures, one for each eye. The image data on each projection structure is further arranged onto a two-dimensional projected picture (CI. for left eye, CR for right eye), which covers the entire sphere. Frame packing is applied to pack the left view picture and right view picture onto the same projected picture. Optionally, region-wise packing is then applied to the pack projected picture onto a packed picture, and the packed picture (D) is given as input to image/video encoding. If the region-wise packing is not applied, the packed picture is identical to the projected picture, and this picture is given as input to image/video encoding.

The image stitching, projection, and region-wise packing process can be carried out multiple times for the same source images to create different versions of the same content, e.g. for different orientations of the projection structure. Similarly, the region-wise packing process can be performed multiple times from the same projected picture to create more than one sequence of packed pictures to be encoded.

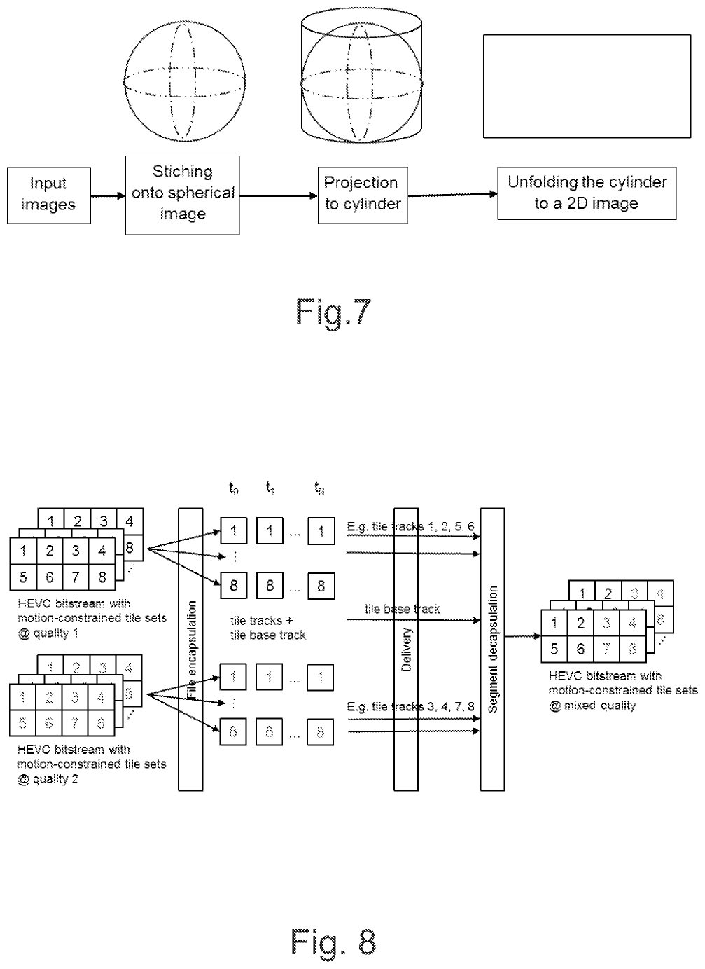

360-degree panoramic content (i.e., images and video) cover horizontally the full 360-degree Field-of-view around the capturing position of an imaging device. The vertical field-of-view may vary and can be e.g. 180 degrees. Panoramic image covering 360-degree Field-of-view horizontally and 180-degree Field-of-view vertically can be represented by a sphere that can be mapped to a bounding cylinder that can be cut vertically to form a 2D picture (this type of projection is known as equirectangular projection). The process of forming a monoscopic equirectangular panorama picture is illustrated in FIG. 7. A set of input images, such as fisheye images of a camera array or a camera device with multiple lenses and sensors, is stitched onto a spherical image. The spherical image is further projected onto a cylinder (without the top and bottom faces). The cylinder is unfolded to form a two-dimensional projected frame. In practice one or more of the presented steps may be merged; for example, the input images may be directly projected onto a cylinder without an intermediate projection onto a sphere. The projection structure for equirectangular panorama may be considered to be a cylinder that comprises a single surface.

In general, 360-degree Content can be mapped onto different types of solid geometrical structures, such as polyhedron (i.e. a three-dimensional solid object containing flat polygonal faces, straight edges and sharp corners or vertices, e.g., a cube or a pyramid), cylinder (by projecting a spherical image onto the cylinder, as described above with the equirectangular projection), cylinder (directly without projecting onto a sphere first), cone, etc. and then unwrapped to a two-dimensional image plane.

In some cases panoramic content with 360-degree horizontal field-of-view but with less than 180-degree vertical field-of-view may be considered special cases of panoramic projection, where the polar areas of the sphere have not been mapped onto the two-dimensional image plane. In some cases a panoramic image may have less than 360-degree horizontal field-of-view and up to 180-degree vertical field-of-view, while otherwise has the characteristics of panoramic projection format.

OMAF allows the omission of image stitching, projection, and region-wise packing and encode the image/video data in their captured format. In this case, images D are considered the same as images Bi and a limited number of fisheye images per time instance are encoded.

For audio, the stitching process is not needed, since the captured signals are inherently immersive and omnidirectional.

The stitched images (D) are encoded as coded images (Ei) or a coded video bitstream (Ev). The captured audio (Ba) is encoded as an audio bitstream (Ea). The coded images, video, and/or audio are then composed into a media file for file playback (F) or a sequence of an initialization segment and media segments for streaming (Fs), according to a particular media container file format. In this specification, the media container file format is the ISO base media file format. The file encapsulator also includes metadata into the file or the segments, such as projection and region-wise packing information assisting in rendering the decoded packed pictures.

The metadata in the file may include:
the projection format of the projected picture,
fisheye video parameters,
the area of the spherical surface covered by the packed picture,
the orientation of the projection structure corresponding to the projected picture relative to the global coordinate axes,
region-wise packing information, and
region-wise quality ranking (optional).

The segments Fs are delivered using a delivery mechanism to a player.

The file that the file encapsulator outputs (F) is identical to the file that the file decapsulator inputs (F′). A file decapsulator processes the file (F′) or the received segments (F's) and extracts the coded bitstreams (E′a, E′v, and/or E′i) and parses the metadata. The audio, video, and/or images are then decoded into decoded signals (B′a for audio, and D′ for images/video). The decoded packed pictures (D′) are projected onto the screen of a head-mounted display or any other display device based on the current viewing orientation or viewport and the projection, spherical coverage, projection structure orientation, and region-wise packing metadata parsed from the file. Likewise, decoded audio (B′a) is rendered, e.g. through headphones, according to the current viewing orientation. The current viewing orientation is determined by the head tracking and possibly also eye tracking functionality. Besides being used by the renderer to render the appropriate part of decoded video and audio signals, the current viewing orientation may also be used the video and audio decoders for decoding optimization.

The process described above is applicable to both live and on-demand use cases.

The human eyes are not capable of viewing the whole 360 degrees space, but are limited to a maximum horizontal and vertical FoVs (HHFOV, HVFoV). Also, a HMD device has technical limitations that allow only viewing a subset of the whole 360 degrees space in horizontal and vertical directions (DHFOV, DVFoV)).

At any point of time, a video rendered by an application on a HMD renders a portion of the 360 degrees video. This portion is defined here as viewport. A viewport may be defined as a region of omnidirectional image or video suitable for display and viewing by the user. A current viewport (which may be sometimes referred simply as a viewport) may be defined as the part of the spherical video that is currently displayed and hence is viewable by the user(s). At any point of time, a video rendered by an application on a head-mounted display (HMD) renders a portion of the 360-degrees video, which is referred to as a viewport. Likewise, when viewing a spatial part of the 360-degree Content on a conventional display, the spatial part that is currently displayed is a viewport. A viewport is a window on the 360-degree world represented in the omnidirectional video displayed via a rendering display. A viewport may be characterized by a horizontal field-of-view (VHFoV) and a vertical field-of-view (VVFoV). In the following, the horizontal field-of-view of the viewport will be abbreviated with HFoV and, respectively, the vertical field-of-view of the viewport will be abbreviated with VFoV.

A recent trend in streaming in order to reduce the streaming bitrate of VR video is the following: a subset of 360-degree video content covering the primary viewport (i.e., the current view orientation) is transmitted at the best quality/resolution, while the remaining of 360-degree video is transmitted at a lower quality/resolution.

In tile-based viewport-dependent 360° streaming, projected pictures are encoded as several tiles (or other image segments, such as subpictures). Some approaches split the video prior to encoding into regions which are encoded independently of each other and decoded with separate decoding instances. However, managing and synchronizing many video decoder instances poses practical problems. Thus, a more practical approach is to encode tiles in a manner that they can be merged to a bitstream that can be decoded with a single decoder instance. Thus, in the context of viewport-dependent 360° streaming, the term tile commonly refers to an isolated region, which depends only on the collocated isolated region in reference pictures and does not depend on any other picture regions. Several versions of the tiles are encoded at different bitrates and/or resolutions. Coded tile sequences are made available for streaming together with metadata describing the location of the tile on the omnidirectional video. Clients select which tiles are received so that the viewport has higher quality and/or resolution than the tiles outside the viewport.

Merging may be defined as an operation that takes two or more coded streams, such as two or more coded tile sequences, as input and produces a single bitstream as output. The bitstream produced as output may comply with a video coding format, such as HEVC or VVC, and may be decoded with a single decoder instance, such as a single HEVC or VVC decoder instance.

An approach of tile-based encoding and streaming, which may be referred to as tile rectangle based encoding and streaming, may be used with any video codec, even if tiles similar to HEVC were not available in the codec or even if motion-constrained tile sets or alike were not implemented in an encoder. In tile rectangle based encoding, the source content is split into tile rectangle sequences before encoding. Each tile rectangle sequence covers a subset of the spatial area of the source content, such as full panorama content, which may e.g. be of equirectangular projection format. Each tile rectangle sequence is then encoded independently from each other as a single-layer bitstream. Several bitstreams may be encoded from the same tile rectangle sequence, e.g. for different bitrates. Each tile rectangle bitstream may be encapsulated in a file as its own track (or alike) and made available for streaming. At the receiver side the tracks to be streamed may be selected based on the viewing orientation. The client may receive tracks covering the entire omnidirectional content. Better quality or higher resolution tracks may be received for the current viewport compared to the quality or resolution covering the remaining, currently non-visible viewports. In an example, each track may be decoded with a separate decoder instance. In another example, tile rectangle sequences are encoded in a manner that encoded tile rectangle sequences may be merged, e.g. by a player, to a single bitstream that may be decoded with a single decoder instance.

In an example of tile rectangle based encoding and streaming, each cube face may be separately encoded and encapsulated in its own track (and Representation). More than one encoded bitstream for each cube face may be provided, e.g. each with different spatial resolution. Players can choose tracks (or Representations) to be decoded and played based on the current viewing orientation. High-resolution tracks (or Representations) may be selected for the cube faces used for rendering for the present viewing orientation, while the remaining cube faces may be obtained from their low-resolution tracks (or Representations).

In an approach of tile-based encoding and streaming, encoding is performed in a manner that the resulting bitstream comprises motion-constrained tile sets. Several bitstreams of the same source content are encoded using motion-constrained tile sets.

In an approach, one or more motion-constrained tile set sequences are extracted from a bitstream, and each extracted motion-constrained tile set sequence is stored as a tile set track (e.g. an HEVC tile track or a full-picture-compliant tile set track) in a file. A tile base track (e.g. an HEVC tile base track or a full picture track comprising extractors to extract data from the tile set tracks) may be generated and stored in a file. The tile base track represents the bitstream by implicitly collecting motion-constrained tile sets from the tile set tracks or by explicitly extracting (e.g. by HEVC extractors) motion-constrained tile sets from the tile set tracks. Tile set tracks and the tile base track of each bitstream may be encapsulated in an own file, and the same track identifiers may be used in all files. At the receiver side the tile set tracks to be streamed may be selected based on the viewing orientation. The client may receive tile set tracks covering the entire omnidirectional content. Better quality or higher resolution tile set tracks may be received for the current viewport compared to the quality or resolution covering the remaining, currently non-visible viewports.

In an example, equirectangular panorama content is encoded using motion-constrained tile sets. More than one encoded bitstream may be provided, e.g. with different spatial resolution and/or picture quality. Each motion-constrained tile set is made available in its own track (and Representation). Players can choose tracks (or Representations) to be decoded and played based on the current viewing orientation. High-resolution or high-quality tracks (or Representations) may be selected for tile sets covering the present primary viewport, while the remaining area of the 360-degree Content may be obtained from low-resolution or low-quality tracks (or Representations).

In an approach, each received tile set track is decoded with a separate decoder or decoder instance.

In another approach, a tile base track is utilized in decoding as follows. If all the received tile tracks originate from bitstreams of the same resolution (or more generally if the tile base tracks of the bitstreams are identical or equivalent, or if the initialization segments or other initialization data, such as parameter sets, of all the bitstreams is the same), a tile base track may be received and used to construct a bitstream. The constructed bitstream may be decoded with a single decoder.

In yet another approach, a first set of tile rectangle tracks and/or tile set tracks may be merged into a first full-picture-compliant bitstream, and a second set of tile rectangle tracks and/or tile set tracks may be merged into a second full-picture-compliant bitstream. The first full-picture-compliant bitstream may be decoded with a first decoder or decoder instance, and the second full-picture-compliant bitstream may be decoded with a second decoder or decoder instance. In general, this approach is not limited to two sets of tile rectangle tracks and/or tile set tracks, two full-picture-compliant bitstreams, or two decoders or decoder instances, but applies to any number of them. With this approach, the client can control the number of parallel decoders or decoder instances. Moreover, clients that are not capable of decoding tile tracks (e.g. HEVC tile tracks) but only full-picture-compliant bitstreams can perform the merging in a manner that full-picture-compliant bitstreams are obtained. The merging may be solely performed in the client or full-picture-compliant tile set tracks may be generated to assist in the merging performed by the client.

It needs to be understood that tile-based encoding and streaming may be realized by splitting a source picture in tile rectangle sequences that are partly overlapping. Alternatively or additionally, bitstreams with motion-constrained tile sets may be generated from the same source content with different tile grids or tile set grids. We could then imagine the 360 degrees space divided into a discrete set of viewports, each separate by a given distance (e.g., expressed in degrees), so that the omnidirectional space can be imagined as a map of overlapping viewports, and the primary viewport is switched discretely as the user changes his/her orientation while watching content with a HMD. When the overlapping between viewports is reduced to zero, the viewports could be imagined as adjacent non-overlapping tiles within the 360 degrees space.

As explained above, in viewport-adaptive streaming the primary viewport (i.e., the current viewing orientation) is transmitted at the best quality/resolution, while the remaining of 360-degree video is transmitted at a lower quality/resolution. When the viewing orientation changes, e.g. when the user turns his/her head when viewing the content with a head-mounted display, another version of the content needs to be streamed, matching the new viewing orientation. In general, the new version can be requested starting from a stream access point (SAP), which are typically aligned with (Sub)segments. In single-layer video bitstreams, SAPs are intra-coded and hence costly in terms of rate-distortion performance. Conventionally, relatively long SAP intervals and consequently relatively long (Sub)segment durations in the order of seconds are hence used. Thus, the delay (here referred to as the viewport quality update delay) in upgrading the quality after a viewing orientation change (e.g. a head turn) is conventionally in the order of seconds and is therefore clearly noticeable and annoying.

There are several alternatives to deliver the viewport-dependent omnidirectional video. It can be delivered, for example, as equal-resolution HEVC bitstreams with motion-constrained tile sets (MCTSs). Thus, several HEVC bitstreams of the same omnidirectional source content are encoded at the same resolution but different qualities and bitrates using motion-constrained tile sets. The MCTS grid in all bitstreams is identical. In order to enable the client the use of the same tile base track for reconstructing a bitstream from MCTSs received from different original bitstreams, each bitstream is encapsulated in its own file, and the same track identifier is used for each tile track of the same tile grid position in all these files. HEVC tile tracks are formed from each motion-constrained tile set sequence, and a tile base track is additionally formed. The client parses tile base track to implicitly reconstruct a bitstream from the tile tracks. The reconstructed bitstream can be decoded with a conforming HEVC decoder.

Clients can choose which version of each MCTS is received. The same tile base track suffices for combining MCTSs from different bitstreams, since the same track identifiers are used in the respective tile tracks.

FIG. 8 shows an example how tile tracks of the same resolution can be used for tile-based omnidirectional video streaming. A 4×2 tile grid has been used in forming of the motion-constrained tile sets. Two HEVC bitstreams originating from the same source content are encoded at different picture qualities and bitrates. Each bitstream is encapsulated in its own file wherein each motion-constrained tile set sequence is included in one tile track and a tile base track is also included. The client chooses the quality at which each tile track is received based on the viewing orientation. In this example the client receives tile tracks 1, 2, 5, and 6 at a particular quality and tile tracks 3, 4, 7, and 8 at another quality. The tile base track is used to order the received tile track data into a bitstream that can be decoded with an HEVC decoder.

Examples on tile-based viewport-dependent streaming were given above with reference to motion-constrained tile sets. It needs to be understood that examples can be similarly realized with reference to independent subpictures or any form of an isolated region. Similarly, while examples were described in relation to HEVC, they may apply similarly to any other codec, such as VVC. It means that MCTS-based viewport adaptive streaming using HEVC and subpicture-based viewport adaptive streaming using VVC may be used equivalently.

In HEVC, one or more (e.g., two) in-loop filters, such as a deblocking filter (DBF) followed by a sample adaptive offset (SAO) filter, may be applied to one or more reconstructed samples.

The DBF may be configured to reduce blocking artefacts due to block-based coding. DBF may be applied (only) to samples located at PU and/or TU boundaries, except at the picture boundaries or when disabled at slice and/or tiles boundaries. Horizontal filtering may be applied (first) for vertical boundaries, and vertical filtering may be applied for horizontal boundaries.

A sample adaptive offset (SAO) may be another in-loop filtering process that modifies decoded samples by conditionally adding an offset value to a sample (possibly to each sample), based on values in look-up tables transmitted by the encoder. SAO may have one or more (e.g., two) operation modes; band offset and edge offset modes. In the band offset mode, an offset may be added to the sample value depending on the sample amplitude. The full sample amplitude range may be divided into 32 bands, and sample values belonging to four of these bands may be modified by adding a positive or negative offset, which may be signalled for each coding tree unit (CTU). In the edge offset mode, the horizontal, vertical, and two diagonal gradients may be used for classification.

A deblocking filter may be applied at face discontinuities.

Deblocking of the block boundaries that are within the proximity of a face discontinuity may be skipped when one or more (possibly all) samples used in a deblocking filter are not located on the same side of the face discontinuity. For example, if a vertical block boundary is within the proximity of a vertical face discontinuity such that one or more (possibly all) samples used in the deblocking filter are not located on the same side of the face discontinuity, the deblocking filter may be disabled across this block boundary. If a horizontal block boundary is within the proximity of a horizontal face discontinuity such that one or more (possibly all) samples used in the deblocking filter are not located on the same side of the face discontinuity, the deblocking filter may be disabled across this block boundary.

The SAO filter may also be applied at face discontinuities such that one or more categories in edge offset mode in SAO for which the samples used in gradient computations are on two different sides of a face discontinuity are disabled. For example, if a face discontinuity is located above or below a current sample position, the vertical and two diagonal categories may be disabled for that sample position. If a face discontinuity is located on the left side of or on the right side of the current sample position, the horizontal and two diagonal categories may be disabled for that sample position. The edge offset mode in SAO may be (completely) disabled for samples that are located next to a face discontinuity.

In VVC, an Adaptive Loop Filter (ALF) with block-based filter adaption is applied. For the luma component, one among 25 filters is selected for each 4×4 block, based on the direction and activity of local gradients, which are derived using the samples values of that 4×4 block.

The ALF may be applied at face discontinuities, wherein ALF may skip sample locations where the largest filter crosses a face discontinuity. For example, the ALF may skip sample locations where the samples used in the filtering process are on two different sides of a face discontinuity. For the luma component, which may use up to a 9×9 diamond filter, the ALF may be disabled for samples located within four samples of a face discontinuity. For the chroma components, which may use a 5×5 diamond filter, the ALF may be disabled for samples located within two samples of a face discontinuity.

The ALF may also be (completely) disabled for blocks that are located next to a face discontinuity and/or for blocks that include a face discontinuity. Disabling ALF may allow a decoder to perform a determination (e.g., of whether ALF is on or off) at the block level. The ALF may be adapted (e.g., turned on/off) at the picture-level and/or block-level. Block-level signalling may be skipped for the disabled block, and the ALF may be inferred to be off for that block.

The ALF classification process may skip one or more sample locations and/or blocks of sample locations where ALF filtering may be disabled. For example, the ALF classification may skip a sample location because the sample location is affected by a face discontinuity (e.g., the samples used in the classification process at that sample location are on two different sides of a face discontinuity). The ALF classification may skip a block if one or more samples within the block are affected by a face discontinuity. The ALF classification may be performed on 2×2 block units.

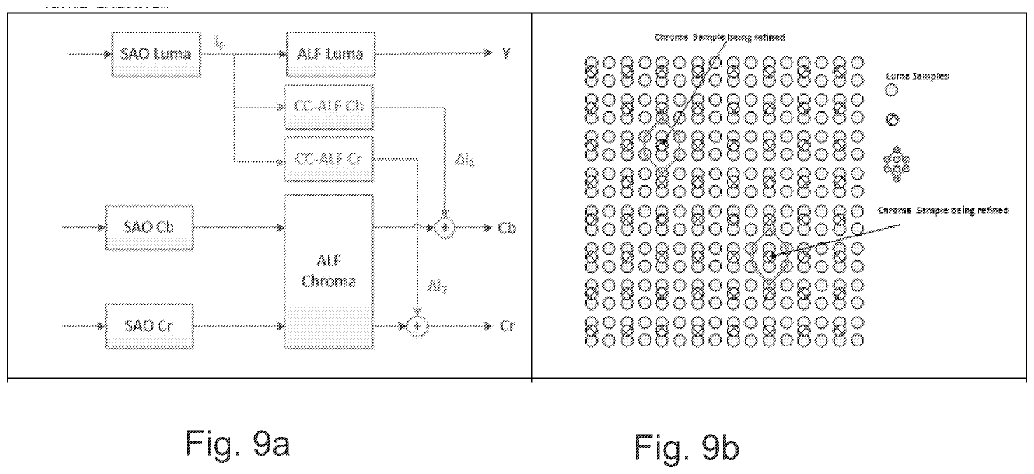

Cross-component ALF (CC-ALF) uses luma sample values to refine each chroma component by applying an adaptive linear filter to the luma channel and then using the output of this filtering operation for chroma refinement. FIG. 9a provides a system level diagram of the CC-ALF process with respect to the SAO, luma ALF and chroma ALF processes. Filtering in CC-ALF is accomplished by applying a linear, diamond shaped filter (FIG. 9b) to the luma channel.

ALF filter parameters are signalled in Adaptation Parameter Set (APS). In one APS, up to 25 sets of luma filter coefficients and clipping value indices, and up to eight sets of chroma filter coefficients and clipping value indices could be signalled. To reduce the overhead, filter coefficients of different classification for luma component can be merged. In slice header, the indices of the APSs used for the current slice are signaled.

Clipping value indices, which are decoded from the APS, allow determining clipping values using a table of clipping values for both luma and chroma components. These clipping values are dependent of the internal bit depth. More precisely, the clipping values may be obtained by the following formula:

$$AlfClip = \{ round ( {2}^{β - α * n} ) for n ∈ [ 0 … N - 1 ] \}$$

where β is equal to the internal bit depth, α is a pre-defined constant value, and N equal to the number of allowed clipping values. In VVC, for example the values of α=2.35 and N=4 may be used. The AlfClip is then rounded to the nearest value with the format of power of 2.

In slice header, up to 7 ALF APS indices can be signaled to specify the luma filter sets that are used for the current slice. The filtering process can be further controlled at CTB level. A flag is signalled to indicate whether ALF is applied to a luma CTB. A luma CTB may choose a filter set among 16 fixed filter sets and the filter sets from APSs. A filter set index is signaled for a luma CTB to indicate which filter set is applied. The 16 fixed filter sets are pre-defined in the VVC standard and hard-coded in both the encoder and the decoder. The 16 fixed filter sets may be referred to as the pre-defined ALFs.

A slice header may contain sh_alf_cb_enabled_flag and sh_alf_cr_enabled_flag to enable (when equal to 1) or disable (when equal to 0) ALF for Cb and Cr components, respectively. When ALF is enabled for either or both chroma components, an ALF APS index is signaled in slice header to indicate the chroma filter sets being used for the current slice. At CTB level, a filter index is signaled for each chroma CTB if there is more than one chroma filter set in the ALF APS.

The filter coefficients are quantized with norm equal to 128. In order to restrict the multiplication complexity, a bitstream conformance is applied so that the coefficient value of the non-central position shall be in the range of −27 to 27−1, inclusive. The central position coefficient is not signalled in the bitstream and is considered as being equal to 128.

For each ALF APS, in the current draft of VVC there are
Maximum of 25 luma ALF filters
Maximum of 8 chroma ALF filters
Maximum of 4 cross-component ALF filters for Cb component
Maximum of 4 cross-component ALF filters for Cr component

To limit the required memory for storing ALF APSs at decoder side, the VVC standard limits the value range for ALS APS ID values so that the storage of up to 8 ALF_APSs is needed.

Table 1 shows the syntax of APS in VVC. Since the APS ID syntax element (referred to as aps_adaptation_parameter_set_id) is a 5-bit unsigned integer (denoted as u(5) in the syntax), it may have a value between 0 to 31, inclusive. However, VVC has a semantic restriction that for ALF APS, the value of APS ID shall be in the range of 0 to 7, inclusive. Thus, the maximum number of ALF APSs that can be referenced in (de)coding of a slice is limited to 8 in VVC. ALF APS content may be defined as an instance of the alf_data( ) syntax structure.

TABLE 1

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits() | |
| } | |

The descriptors specifying the parsing process of each syntax element are defined in the VCC specifications as follows:
ae(v): context-adaptive arithmetic entropy-coded syntax element.
b(8): byte having any pattern of bit string (8 bits). The parsing process for this descriptor is specified by the return value of the function read_bits(8).
f(n): fixed-pattern bit string using n bits written (from left to right) with the left bit first. The parsing process for this descriptor is specified by the return value of the function read_bits(n).
i(n): signed integer using n bits. When n is “v” in the syntax table, the number of bits varies in a manner dependent on the value of other syntax elements. The parsing process for this descriptor is specified by the return value of the function read_bits(n) interpreted as a two's complement integer representation with most significant bit written first.
se(v): signed integer 0-th order Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.
ue(v): unsigned integer 0-th order Exp-Golomb-coded syntax element with the left bit first.

Table 2 shows the syntax of indicating active/used APS in the slice header in the current draft of VVC. A similar syntax is valid when active APSs are signaled in picture header.

TABLE 2

| | Descriptor |
|---|---|
| slice_header( ) { | |
| sh_picture_header_in_slice_header_flag | u(1) |
| ... | |
| if( sps_alf_enabled_flag && | |
| !pps_alf_info_in_ph_flag ) { | |
| sh_alf_enabled_flag | u(1) |
| if( sh_alf_enabled_flag ) { | |
| sh_num_alf_aps_ids_luma | u(3) |
| for( i = 0; i < sh_num_alf_aps_ids_luma; i++ ) | |
| sh_alf_aps_id_luma[ i ] | u(3) |
| if( sps_chroma_format_idc != 0 ) { | |
| sh_alf_cb_enabled_flag | u(1) |
| sh_alf_cr_enabled_flag | u(1) |
| } | |
| if( sh_alf_cb_enabled_flag \| \| | |
| sh_alf_cr_enabled_flag ) | |
| sh_alf_aps_id_chroma | u(3) |
| if( sps_ccalf_enabled_flag ) { | |
| sh_alf_cc_cb_enabled_flag | u(1) |
| if( sh_alf_cc_cb_enabled_flag ) | |
| sh_alf_cc_cb_aps_id | u(3) |
| sh_alf_cc_cr_enabled_flag | u(1) |
| if( sh_alf_cc_cr_enabled_flag ) | |
| sh_alf_cc_cr_aps_id | u(3) |
| } | |
| } | |
| } | |
| if( ph_Imcs_enabled_flag && | |
| !sh_picture_header_in_slice_header_flag ) | |
| sh_Imcs_used_flag | u(1) |
| if( ph_explicit_scaling_list_enabled_flag && | |
| !sh_picture_header_in_slice_header_flag ) | |
| sh_explicit_scaling_list_used_flag | u(1) |
| ... | |
| byte_alignment( ) | |
| } | |

Table 3 shows the syntax of signaling ALF related parameters in CTU level in the current draft of VVC.

TABLE 3

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_sao_luma_used_flag \| \| sh_sao_chroma_used_flag ) | |
| sao( CtbAddrX, CtbAddrY ) | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| if( sh_alf_cb_enabled_flag ) { | |
| alf_ctb_flag[ 1 ][ CtbAddrX ][ CtbAddrY ] | ae(v) |
| if( alf_ctb_flag[ 1 ][ CtbAddrX ][ CtbAddrY ] | |
| && alf_chroma_num_alt_filters_minus1 > 0 ) | |
| alf_ctb_filter_alt_idx[ 0 ][ CtbAddrX ][ CtbAddrY ] | ae(v) |
| } | |
| if( sh_alf_cr_enabled_flag ) { | |
| alf_ctb_flag[ 2 ][ CtbAddrX ][ CtbAddrY ] | ae(v) |
| if( alf_ctb_flag[ 2 ][ CtbAddrX ][ CtbAddrY ] | |
| && alf chroma num_alt_filters_minus1 > 0) | |
| alf_ctb_filter_alt_idx[ 1 ][ CtbAddrX ][ CtbAddrY ] | ae(v) |
| } | |
| } | |
| if( sh_alf_cc_cb_enabled_flag ) | |
| alf_ctb_cc_cb_idc[ CtbAddrX ][ CtbAddrY ] | ae(v) |
| if( sh_alf_cc_cr_enabled_flag ) | |
| alf_ctb_cc_cr_idc[ CtbAddrX ][ CtbAddrY ] | ae(v) |
| if( sh_slice_type == I && sps_qtbtt_dual_tree_intra_flag ) | |
| dual_tree_implicit_qt_split( xCtb, yCtb, CtbSizeY, 0) | |
| else | |
| coding_tree( xCtb, yCtb, CtbSizeY, CtbSizeY, 1, 1, 0, 0, 0, 0, 0, | |
| SINGLE_TREE, MODE_TYPE_ALL ) | |
| } | |

An ALF APS carries ALF filter coefficients and persists for one or more complete pictures until the next ALF APS having the same identifier. The ALF APS filters are decided at the encoding time and the ALF APS identifiers for subpictures within the same picture are dependently calculated together.

In VVC, updating an ALF APS within a coded picture is not allowed. Moreover, the number of ALF APSs for (de)coding a slice is limited to 8 by the current version of VVC.

These limitations may cause problems when different subpictures coded in a non-coordinated manner (i.e., each subpicture or a group of subpictures coded using an independent encoder instance, e.g. using a distributed subpicture encoding approach as discussed earlier) are needed to be aggregated or merged into a single coded picture. For example, in a distributed subpicture-based encoding architecture, which is required for 360° content encoding because of the high fidelity (resolution and quality) requirement for this kind of content, the subpictures are encoded using different processing nodes. In case of non-coordinated encoding among subpictures, different subpictures with the same ALF APS identifiers, while potentially containing different filter coefficients, may be aggregated into a single picture. This causes a failure in aggregating different subpictures within a VVC-conforming picture.

A similar issue exists in subpicture-based viewport-adaptive streaming (VAS) at the merging stage of different subpictures from high-quality and low-quality bitstreams, if different content versions have been coded with non-coordinated ALF parameters. In VAS, it is desired to enable merging of subpictures bitstreams from different quality/resolution levels into a single coded picture to form a full 360° content.

Furthermore, merging of bitstreams as subpicture sequences into a single destination bitstream may occur in other use cases, such as 1) Multipoint Control Unit of a multipoint video conference mixes/merges media content coming from several endpoints into a single destination bitstream that is transmitted to one or more endpoints; 2) A device includes or is connected to multiple cameras that capture visual content, after which individual captures are encoded as independent bitstreams and then merged to a single bitstream; 3) Game streaming where game content and camera-captured content may be encoded separately and then merged as subpicture sequences into a single bitstream; 4) Multiple incoming video elementary streams that are merged as subpictures or alike into an output video bitstream.

Case 4 in the previous paragraph may apply for example when an overlay video bitstream or alike is merged into the same output bitstream with a “background” video bitstream. An overlay may for example represent an advertisement, a secondary camera, or another channel of a television broadcast, and the background video bitstream may represent the actual video content. The merging is done, for example, by replacing one or more subpictures of the background video bitstream with one or more subpictures of the overlay video bitstream. As another example, the merging is done by including both the background video bitstream and the overlay video bitstream as non-overlapping sets of subpictures in the output video bitstream, and including rendering instructions in or along the output video bitstream to display the overlay on a desired position on top of the background video.

However, the ALF-related limitations described above in the VVC standard and its typical implementations, such as its reference implementation VTM, may disallow a standard-compliant merging operation of bitstreams generated by non-coordinated encoding as subpicture sequences into a destination bitstream.

Disabling the use of ALF APSs in encoding is one way to avoid problems related to ALF APS identifier value clashes when merging bitstreams as subpicture sequences into a destination bitstream. However, disabling the use of ALF APSs reduces the achievable compression efficiency.

Now an improved method for enabling more flexible allocation of ALF APSs is introduced.

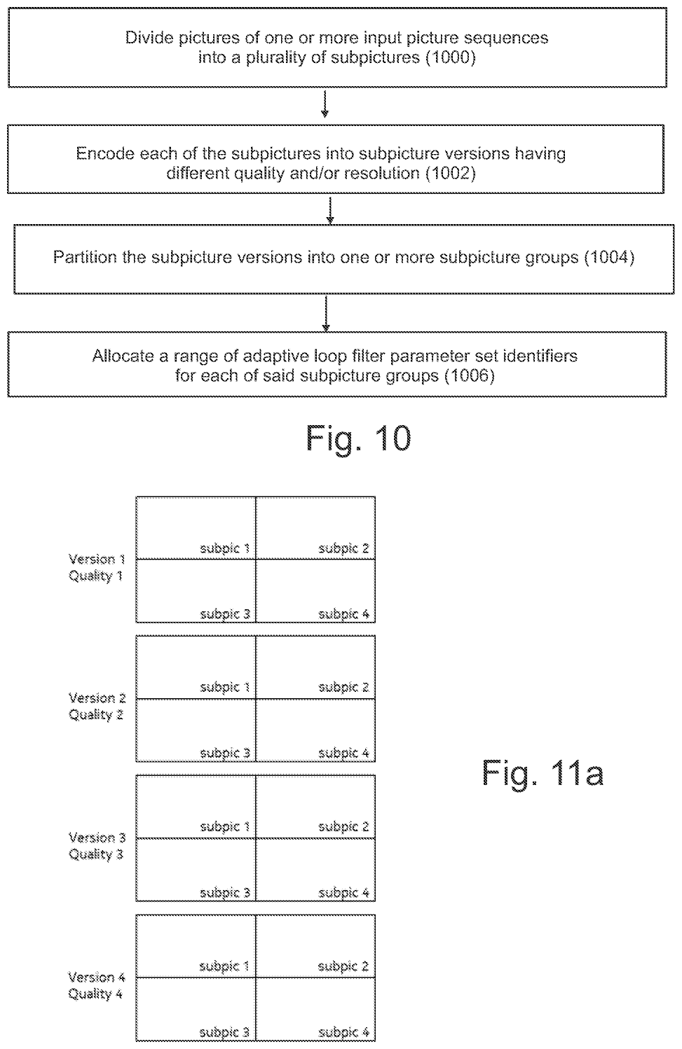

The method according to an aspect, as shown in FIG. 10, comprises dividing (1000) pictures of an input picture sequence into a plurality of subpictures; encoding (1002) each of the subpictures into subpicture versions having different quality and/or resolution; partitioning (1004) the subpicture versions into one or more subpicture groups; and allocating (1006) a range of adaptive loop filter parameter set identifiers for each of said subpicture groups.

According to an embodiment, the range of adaptive loop filter parameter set identifiers for a subpicture group is selected to include consecutive numbers of allowed adaptive loop filter parameter set identifiers.

According to an embodiment, the range of adaptive loop filter parameter set identifiers for a subpicture group is selected to include one or more identifiers from an allowed range of adaptive loop filter parameter set identifiers, e.g. {1, 3, 4} identifiers may be selected for a subpicture group from the allowed range of 0 to 7, inclusive.

Accordingly, an allocation strategy for adaptive loop filter parameter set identifiers is provided, which is based on a subpicture group (SPG) concept. A subpicture group comprises one or more coded subpicture sequences or subpicture versions that use the same set of adaptive loop filter identifier values and, depending on embodiments described later, may use the same adaptive loop filter coefficients or may allow different adaptive loop filter coefficients. An adaptive loop filter identifier value may be an ALF APS ID and adaptive loop filter coefficients may be provided in ALF APS(s). As a result of the partitioning, the subpicture group may contain a single subpicture sequence, a group of subpicture sequences, which may represent the same or different quality/resolution versions, or a sequence of complete pictures. Each SPG may be coded independently from the other subpicture groups. This enables the usage of both pre-defined ALFs and ALF APS(s) within a coded picture on the SPG basis. Moreover, this enables an encoder that encodes an SPG to derive a new set of coefficients for an ALF APS whose identifier is allocated to the SPG. The adaptive loop filter parameter set identifier allocation strategy, as described herein, enables desired combinations of subpictures coming from different versions of source content, which may form e.g. a full representation of 360° content, to result in a VVC conforming bitstream (for example, total number of ALF APS IDs are less than the maximum number of ALF APS IDs, which is 8 in VVC).

According to an embodiment, a unique range of adaptive loop filter parameter set identifiers may be allocated for each of said subpicture groups. A unique range of adaptive loop filter parameter set identifiers for a subpicture group may be defined to be such that it does not overlap with the range of adaptive loop filter parameter set identifiers of any other subpicture group. This case enables any combination of subpictures coming from different versions of source content, which may form e.g. a full representation of 360° content, to result in a VVC conforming bitstream.

According to an embodiment, partitioning to subpicture group and/or allocation of adaptive loop filter parameter set identifiers to different subpicture groups may be done in different time periods, for example each picture, each few picture, or each group of pictures (GOP). In this case, some information (e.g. rate distortion gain of using adaptive loop filter for each subpicture version, some of correlation information used in encoder side algorithm of parameters and coefficients derivation of adaptive loop filter parameter set identifiers such as correlation between samples of reconstructed pictures and original picture) may be collected from or coordinated among different subpicture group encodings.

According to an embodiment, the number of ALF APS IDs may be allocated to each subpicture group, and same ALF APS ID may be used during encoding of two or more subpicture groups. During the merging of subpictures, e.g. for streaming purpose, subpicture groups and subpictures for merging are selected in a manner that ALF APS IDs of the different subpicture groups selected for merging are unique ALF APS IDs.

According to an embodiment, an entity creates and conveys a control signal to control more than one video encoder or more than one video encoder instance. The entity that creates and conveys the control signal may for example be the entity that also merges bitstreams created by video encoder(s) as coded subpicture sequences to another video bitstream. The control signal may comprise said range of ALF parameter set identifiers that are allowed to be used in encoding.

According to an embodiment, the control signal is formatted for example as one or more optional media parameters (a.k.a. MIME parameters). In an embodiment, the control signal is used in an offer and/or in an answer within one or more optional media parameters in SDP offer/answer negotiation.

According to an embodiment, the control signal is, or is a part of, a configuration file or alike that defines the encoding settings used by an encoder.

According to an embodiment, the control signal is, or is a part of, an application programming interface or alike that is used to control an encoder.

According to an embodiment, the method comprises indicating an adaptive loop filter parameter set identifier value within said range using one or more syntax elements included in an adaptation parameter set. Thus, the signalling of the filter coefficients and clipping value indices to be used may be carried out, for example on slice basis, by the APSs used for the current slice.

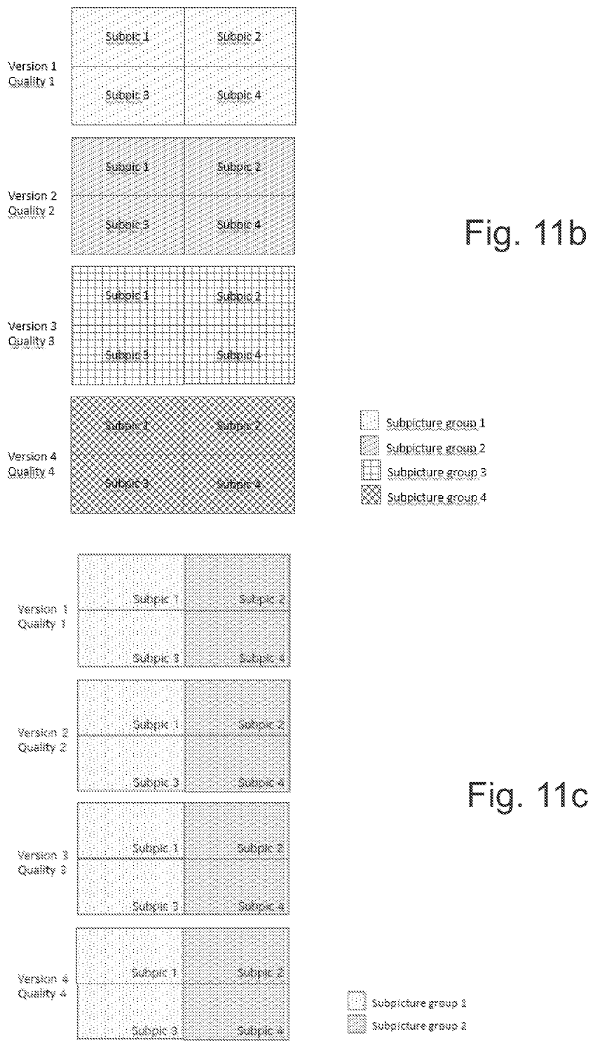

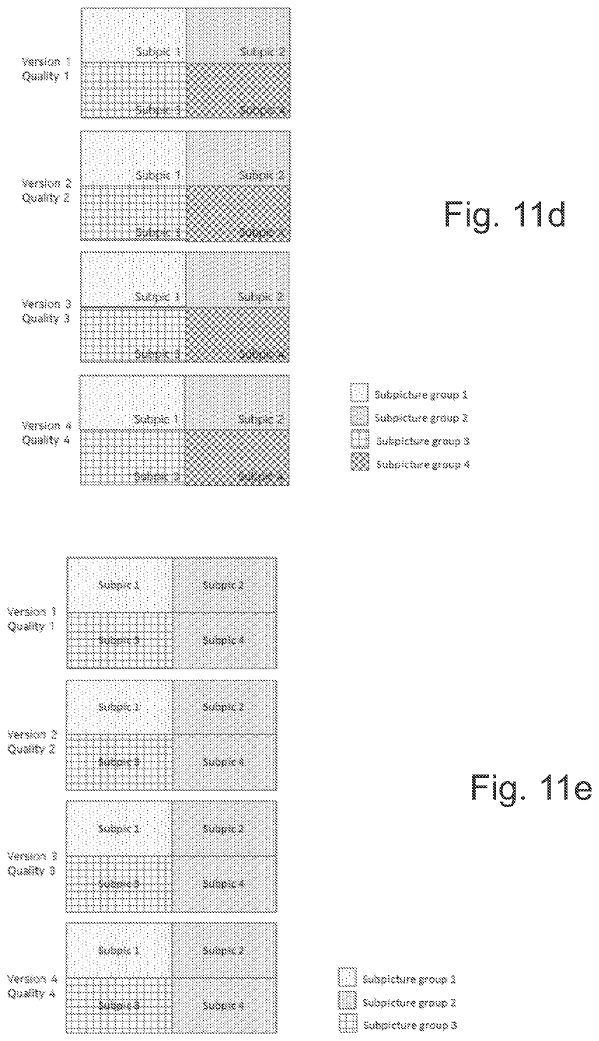

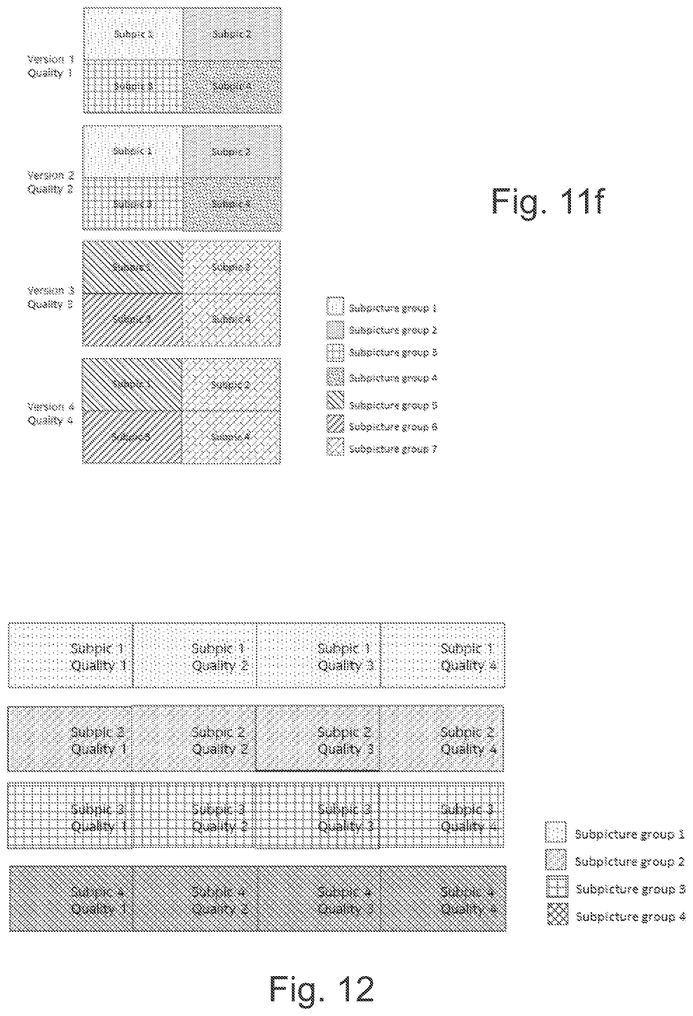

The allocation strategy is especially useful in viewport-adaptive streaming (VAS), where each video content may be divided into several subpictures, and each of them is coded in different quality or resolution versions and stored in the server side. In a typical VAS scenario, the source content may be coded at only two quality versions, and in other cases, for example more than 4 versions may be presented. A quality version may be defined as a set of subpicture versions that have a similar picture quality or a similar bitrate. The plurality of subpicture versions is illustrated in an example of FIG. 11a, where 4 versions of source content are coded at different quality levels with a subpicture grid of 2×2. Thus, there are 2×2×4=16 subpicture versions.

According to an embodiment, the method comprises partitioning all the subpicture versions of a quality/resolution version into one subpicture group; and dividing said range of adaptive loop filter parameter set identifiers for each subpicture group such that each subpicture group has its own unique range of adaptive loop filter parameter set identifiers.

Thus, when the SPG comprises the whole picture, a picture level allocation of adaptive loop filter parameter set identifiers may be carried out such that the maximum number of ALF APS identifier values is divided among different versions (at different resolution or quality) of source content such that each version has its own unique range of ALF APS identifiers.

According to an embodiment, the method comprises partitioning one or more subpicture versions into a corresponding number of subpicture groups, each consisting of one subpicture version; and allocating each subpicture version with its own unique range of adaptive loop filter parameter set identifiers.

Thus, when the SPG comprises only one subpicture version, a subpicture level allocation of adaptive loop filter parameter set identifiers and/or a subpicture level derivation of adaptive loop filter coefficients may be carried out such that each subpicture version has ALF APS(s) with a unique range of ALF APS identifiers.

According to an embodiment, the method comprises partitioning a plurality of subpicture versions into at least one subpicture group consisting of a plurality of subpicture version; and allocating each subpicture group with its own unique range of adaptive loop filter parameter set identifiers.

Thus, when the SPG comprises a plurality of subpicture versions, a subpicture group level allocation of adaptive loop filter parameter set identifiers and/or a subpicture level derivation of adaptive loop filter coefficients may be carried out such that for each SPG a certain number of unique ALF APS identifiers is assigned and/or adaptive loop filter coefficients are derived for an SPG. It is noted that the grouping of subpictures can be performed over subpictures from the same bitstream version or across subpictures from different versions.

According to an embodiment, the method comprises allocating a maximum number of adaptive loop filter parameter set identifiers for each subpicture group. Thus, by determining and allocating each subpicture group with less than or equal to a maximum number of ALF APSs, the number of used ALF APSs for coding of each SPG cannot exceed this maximum number.

According to an embodiment, the method comprises allocating less than or equal to a maximum number of adaptive loop filter parameter set identifiers for all subpicture groups in total. Thus, to guarantee the constraint of having maximum of 8 distinct ALF APS identifier values according to VVC standard, the total number of allocated ALF APS identifiers to different SPGs is determined to be less than or equal to the maximum number of distinct ALF APS identifier values allowed by the VVC standard.

According to an embodiment, the method comprises determining a total number of allocated adaptive loop filter parameter set identifiers for all subpicture groups such that the number of adaptive loop filter parameter set identifier values in any bitstream merged from all subpicture groups is less than or equal to the maximum number of adaptive loop filter parameter set identifier values. In this embodiment, the SPGs that are allowed to be merged may be constrained, e.g. according to the maximum field of view, such that the maximum number of ALF APS identifier values allowed by the VVC standard is not exceeded.

According to an embodiment, the method comprises encoding the subpicture group using a single video encoder instance. Thus, if each subpicture group is coded using a single video encoder instance, the same ALF APSs may be used for all subpictures inside that subpicture group.

According to an embodiment, the method comprises encoding the subpicture versions within the subpicture group using two or more video encoder instances. Thus, subpicture versions of a subpicture group may be coded using different encoder instances. In such a case, the encoding is preferably carried out in a coordinated manner to guarantee having the same ALF APSs in all instances.

According to an embodiment, the method comprises encoding each subpicture group using multi-rate encoder. Multi-rate encoder receives one input uncompressed video content (e.g. a collection of subpictures), and compress the input and creates several versions (i.e. bitstreams) of that with different bitrates, quality levels or resolutions.

The number of adaptive loop filter parameter set identifier values for each subpicture group may differ, depending on various constraints. In an embodiment, subpicture groups may have an equal number of ALF APS identifier values. In another embodiment, a higher number of ALF APS identifier values may be allocated to the subpicture groups having their coding rate distortion (RD) performance sensitive to number of ALF APSs. In another embodiment, no ALF APS may be allocated to a subpicture group. For example, subpictures in the north or south poles of equirectangular projection content may be grouped together as a subpicture group and no ALF APSs may be allocated to this subpicture group. As another example, subpictures in the top or bottom faces of CMP, or subpictures close to the center of top and bottom faces of CMP may be grouped together as a subpicture group and no ALF APSs may be allocated to this subpicture group. As another examples, subpictures in different 360-degree projection formats that contain content from top (e.g. sky) or bottom (e.g. ground) side may be grouped together as a subpicture group and no ALF APSs may be allocated to this subpicture group.

In an embodiment, each quality version of a particular quality (including all subpicture versions in that quality version) may be grouped as one subpicture group. In this case, the total number of ALF APSs (e.g. 8) may be equally divided among different subpicture groups/versions. In another case, the number of ALF APS may be allocated according to the quality/resolution level of each version, For example, a higher number of ALF APS identifier values may be allocated to the subpicture groups coded in higher quality or resolution.

In an embodiment, subpicture versions of a quality version may be divided into multiple subpicture groups. The number of subpicture groups in different quality version may be different.

In an embodiment, co-located subpictures versions across different quality/resolution versions may be grouped into a SPG. The number of ALF APS identifier values can be either evenly or unevenly allocated among different SPGs.

It can be concluded that the different methods of assigning subpicture versions into SPGs, and also the different strategies of allocating number of adaptive loop filter parameter set identifiers to each SPG, lead to various possible permutations regarding the number of subpicture versions in SPGs, as well as the number of ALF APS identifiers allocated for subpicture versions and/or SPGs. Some of these permutations are illustrated in examples shown in FIGS. 11a-11f.

FIG. 11a shows a 2×2 subpicture partitioning (i.e. 4 subpicture versions) of source content coded at 4 different quality versions, which is used as a basis for partitioning in FIGS. 11b-11f.

FIG. 11b shows an implementation alternative, where the 4 subpicture versions in each quality version of the content are grouped into a subpicture group. Two ALF APS identifier values may be allocated to each group/version, wherein the total number of ALF APS identifier values does not exceed the maximum number of ALF APS identifier values allowed in VVC, i.e. 8.

FIG. 11c shows another implementation alternative, where the picture of each quality version is divided to two subpicture groups, each comprising two subpictures. For example, in each quality version, subpictures 1 and 3 can be assigned to subpicture group 1 and subpictures 2 and 4 can be assigned to subpicture group 2. One or more ALF APS identifier values is allocated for each group in each quality version. In this case, the total number of ALF APS identifier values reaches to 8 as well. In this case, each subpicture group may be encoded using multi-rate encoder which receives one original content and create several compressed version of that content using different bitrates or quality levels.

FIG. 11d shows yet another implementation alternative, where co-located subpictures across different quality versions are grouped as a subpicture group. In this case, each subpicture is coded at the target quality levels with the same ALF APS content and the same ALF APS identifier(s) are used across versions of each group of co-located subpictures. In this scenario, two ALF APS identifier values may be allocated for each subpicture group, resulting in 8 ALF APS identifier values in total. Each subpicture version in a subpicture group may be coded using an independent encoder instance in a coordinated manner where ALF APS information is shared among different subpictures within the subpicture group. Alternatively, as shown in FIG. 12, different subpicture quality versions of each subpicture group may be packed together and coded using a single encoder instance, while assigning different quality level, or bitrate or quantization parameter to each of subpicture versions.

Yet another alternative may be used provided that whenever a switch from one quality version to another (referred to as destination quality version) within a subpicture group takes place, ALF APS(s) that apply to the destination quality version are merged together with the subpicture(s) of the destination quality version into the bitstream to be decoded. In this embodiment, the same ALF APS identifier(s) are used across versions in the same subpicture group but each subpicture version may be encoded with different ALF APS content. In other words, an encoder may derive the ALF APS coefficients based on one subpicture version independently of other subpicture versions in the same subpicture group or in other subpicture groups.

For these kinds of subpicture groups, an embodiment for merging comprises the following: To comprise a current coded picture in the merged bitstream, a subpicture version is selected from a subpicture group. If a different subpicture version from the same subpicture group was selected for the previous coded picture, in decoding order, ALF APS(s) that apply to the destination quality version are inserted into the current coded picture (e.g. before any subpictures). The selected subpicture version is added to the current coded picture. The process of selecting a subpicture version, adding ALF APS(s) (when needed) into the current coded picture, and adding the selected subpicture version into the current coded picture may be repeated for all subpicture groups used as input for merging the current coded picture. After completing the merging for the current coded picture, the process may proceed to the next picture, in decoding order.

FIG. 11e shows yet another implementation alternative, where different subpicture groups may contain varying number of subpicture versions across the quality versions. In the example of FIG. 11e, three subpicture groups 1, 2 and 3 are provided, where the subpicture group 1 contains only one subpicture version (subpicture version 1) and the subpicture group 3 contains only one subpicture version as well (subpicture version 3), while the subpicture group 2 contains two subpicture versions (subpicture versions 2 and 4).

FIG. 11f shows yet another implementation alternative, where subpicture versions of the close versions may be grouped into a subpicture group. In the example of FIG. 11f, seven subpicture groups 1, 2, 3, 4, 5, 6 and 7 are provided. The subpicture group 1 consists of two subpicture versions of the subpicture 1 from the quality versions 1 and 2 of the coded content. Similarly, the subpicture groups 2, 4 and 4 consist of two subpicture versions of the subpictures 2, 3 and 4, correspondingly, from the quality versions 1 and 2 of the coded content. The subpicture groups 5 and 6 each consists of two subpicture versions of the subpictures 1 and 2, correspondingly, from the quality versions 3 and 4 of the coded content. The subpicture group 7 has a higher number of 4 subpicture versions of the subpictures 3 and 4 from the quality versions 3 and 4.

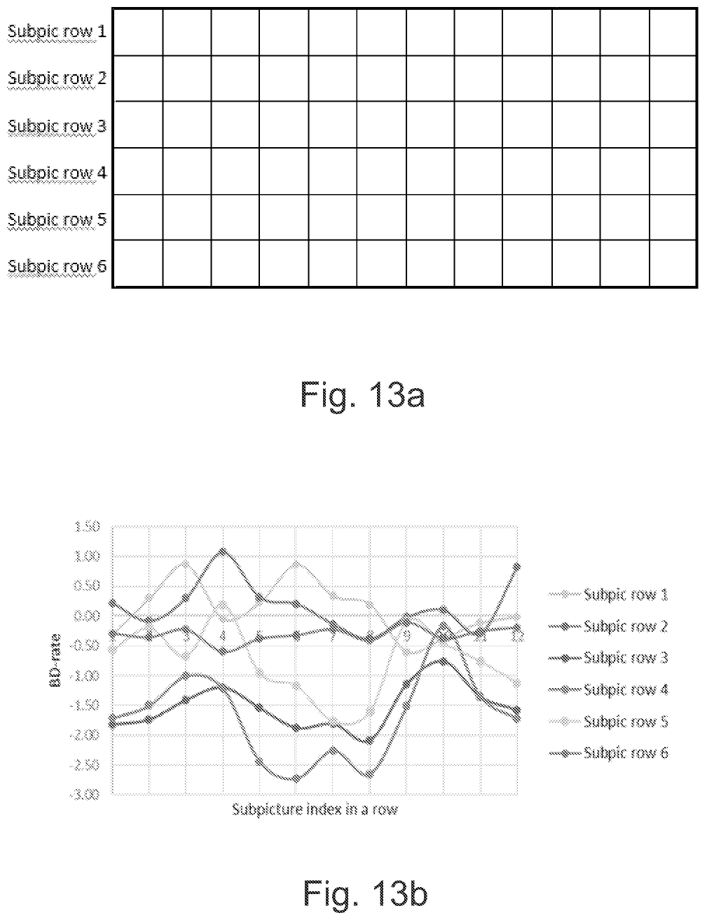

FIGS. 13a and 13b show yet another implementation alternative according to an embodiment comprising determining one or more subpicture groups obtaining an improvement on the coding rate distortion (RD) performance via usage of adaptive loop filter parameter set identifiers; and determining a higher number of adaptive loop filter parameter set identifiers to be allocated to said one or more subpicture groups. Thus, the ALF APS identifier allocation may be performed according to the impact of the use of ALF APS(s) on the RD performance of subpicture versions. FIG. 13a shows an example of a 12×6 subpicture grid, thus having six subpicture rows. FIG. 13b shows the subpicture wise RD performance impact of an ALF APS relative to not using ALF APS for the subpicture, measured and averaged over multiple equirectangular projection video clip. For example, the subpicture rows 1, 2, 5, 6, performing on higher values in terms of BD (Bjontegaard Delta) rate, may be assigned to a subpicture group in which no ALF APS is allocated. The ALF APS identifier values may be then allocated to the subpictures along the equator, i.e. subpicture rows 3 and 4.

It is noted that the allocation strategy for adaptive loop filter parameter set identifiers as described herein enables also embodiments where the total number of allocated ALF APS identifiers to different SPGs is greater than the maximum number of ALF APS identifiers indicated in the VVC standard.

According to an embodiment, the method comprises allocating one or more same adaptive loop filter parameter set identifiers to a plurality of subpicture groups. Thus, the same ALF APS ID value(s) may be allocated to different SPGs. Consequently, ALF APSs having the same ALF APS ID may have different content in different SPGs. The allocation of ALF APS ID value(s) to SPGs may be performed in a manner that SPGs with the same ALF APS ID values but different ALF APS content for the same ALF APS ID values are not merged into a bitstream to be decoded under certain constraints, herein referred to as merging constraints. When merging constraints are obeyed in the merging operation, the ALF APS ID value ranges of SPGs are unique in the merged bitstream.

According to an embodiment, the merging constraints may comprise, but are not necessarily limited to, to one or more of the following:
Maximum field of view (FOV) that can be covered by high-resolution and/or high-quality SPGs and may be expressed with horizontal and vertical FOV. Alternatively, this can be expressed by maximum number of spherically adjacent SPGs that can be covered by high-resolution and/or high-quality SPGs
Certain viewing orientation range, such as an allowed elevation range

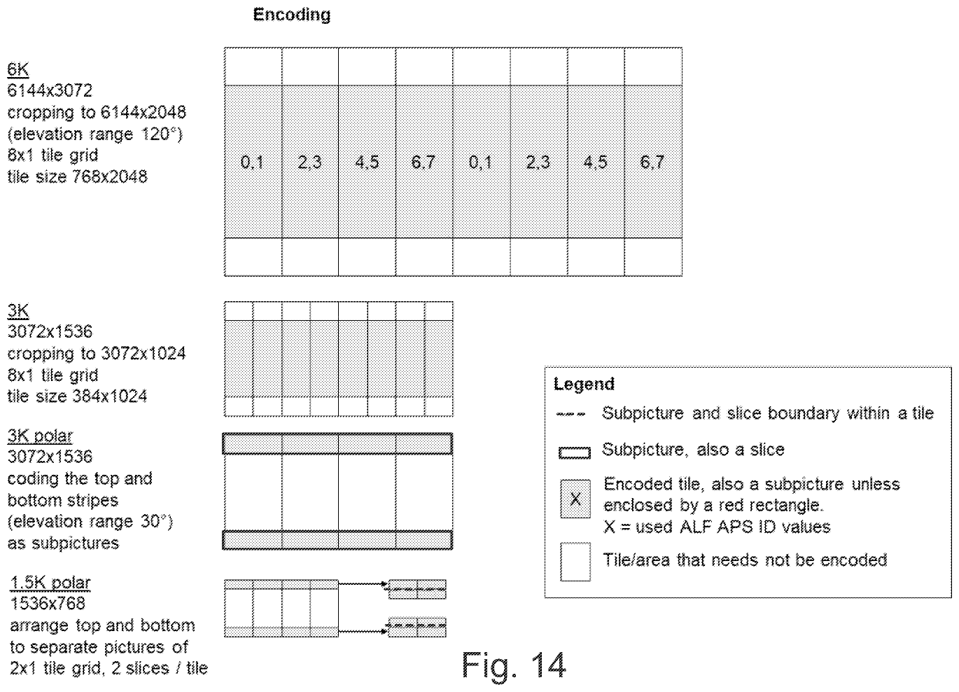

An example for 6K effective ERP resolution with VVC Level 5, 5.1 or 5.2 decoding capability is shown in FIG. 14. VVC Levels 5, 5.1, and 5.2 allow bitstreams to have 4K spatial resolution and require decoding capacity of 4K spatial resolution, wherein 4K may for example be defined as a maximum of 8 912 896 luma samples per picture. Therein, the content for the viewport originates from an ERP sequence of 6K resolution (6144×3072 luma samples). The merging constraints cause 4 spherically adjacent high-resolution (6K) subpictures to be merged into a bitstream to be decoded.

The following pre-processing and encoding steps are carried out in the arrangement according the example of FIG. 14:
The source content is resampled to three spatial resolutions, namely 6K (6144×3072), 3K (3072×1536), and 1.5K (1536×768).
The 6K and 3K sequences are cropped to 6144×2048 and 3072×1024, respectively, by excluding 30° elevation range from the top and the bottom. The cropped 6K and 3K input sequences are split to an 8×1 grid, where each grid cell is coded as a single tile, a single slice and a single independent subpicture. 8 subpicture groups are allocated to the 6K subpictures, where each subpicture group is allocated with two ALF APS ID values in a manner that any 4 spherically adjacent subpicture groups have non-overlapping ALF APS ID allocations e.g. as indicated in FIG. 14. Accordingly, the total number of ALF APS IDs is more than 8, which may not be significant during encoding, but it needs to be taken into account during merging.
The top and bottom stripes of size 3072×256 corresponding to 30° elevation range are extracted from the 3K input sequence. The top stripe and the bottom stripe are encoded as separate bitstreams with a 4×1 tile grid in a manner that the row of tiles is a single subpicture.
The top and bottom stripes of size 1536×128 corresponding to 30° elevation range are extracted from the 1.5K input sequence. Each stripe is arranged into a picture of size 768×256 for example by arranging the left side of the stripe on the top of the picture and the right side of the stripe at the bottom of the picture. The picture sequence containing the rearranged top stripes is encoded separately from that containing the rearranged bottom stripes. Each bitstream is coded using a 2×1 tile grid and two slices within a tile, where each slice contains 384×128 luma samples. Each slice is encoded as an independent subpicture.

The above-described encoding enables merging of the following encoded subpictures into a VVC bitstream to be decoded as follows:
Any four spherically adjacent 6K subpictures, e.g. according to the viewing orientation
Four subpictures from the cropped 3K version complementing the chosen 6K subpictures so that the entire azimuth range of 360° is covered
The top or bottom stripe subpicture from the 3K resolution e.g. depending on whether the targeted viewing orientation is above or below the equator, respectively, and
The top or bottom stripe bitstream from the 1.5K resolution e.g. depending on whether the viewing orientation is below or above the equator, respectively.

FIG. 15 illustrates a bitstream merged from the selected subpictures. A 6×2 tile grid is used in the bitstream. Tile column are of 768, 768, 768, 768, 384, and 384 luma samples and tile row heights are 2048 and 256 luma samples. Each tile encapsulating content from the cropped 3K bitstream or from the top or bottom stripe of the 1.5K resolution contains two slices. Each slice is also an independent subpicture. The picture size of the merged bitstream is 3840×2304, which conforms to VVC Level 5, 5.1 or 5.2 for 30, 60, or 120 Hz picture rate, respectively.

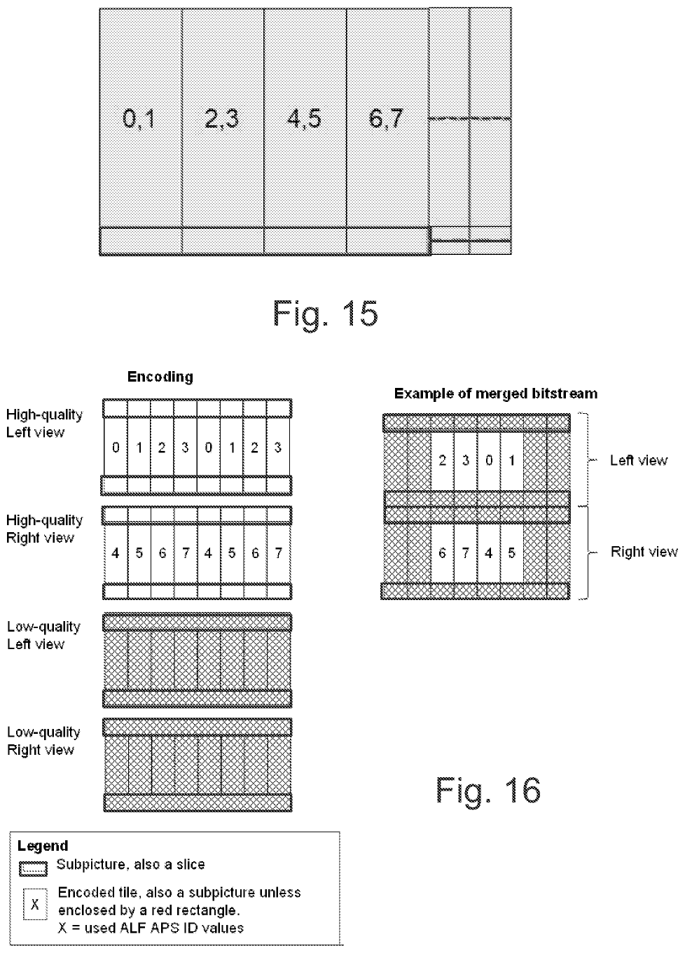

An example of stereoscopic mixed-quality ERP is presented in FIG. 16. The merging constraints are such that up to 4 spherically adjacent “middle-stripe” subpictures from each view are merged into a bitstream to be decoded. Alternatively, the viewing orientation may be limited so that extreme elevations of the viewing orientation that would require more than 4 spherically adjacent “middle-stripe” subpictures are disallowed in the user interface. This arrangement avoids coordinated encoding between views and qualities and allocates ALF APSs to the high-quality subpictures, since a greater bitrate saving is likely to be achieved when the high-quality subpictures can utilize ALF APSs.

Pre-processing and encoding: The source content is stereoscopic. Both views are encoded at two qualities or bitrates. An 8×3 tile grid may be used for encoding of each view, with tile heights corresponding to e.g. 30°, 120° and 30° elevation ranges, and all tile widths corresponding to 45° azimuth range. The top tile row may be encoded as one independent subpicture, each tile in a middle tile row may be encoded as one independent subpicture, and the bottom tile row may be encoded as one independent subpicture. 16 subpicture groups may be allocated, each having one high-quality subpicture and one ALF APS ID value in a manner that any 4 spherically adjacent subpicture groups within the same view have non-overlapping ALF APS ID allocations and spatially collocated subpictures in different views have different ALF APS ID allocations, e.g. as indicated in FIG. 16.

An example of a merged bitstream for decoding is also presented in FIG. 16. In this example, the 4 center-most subpictures from the ERP are chosen from the high-quality versions, whereas the remaining subpictures are from the low-quality versions.

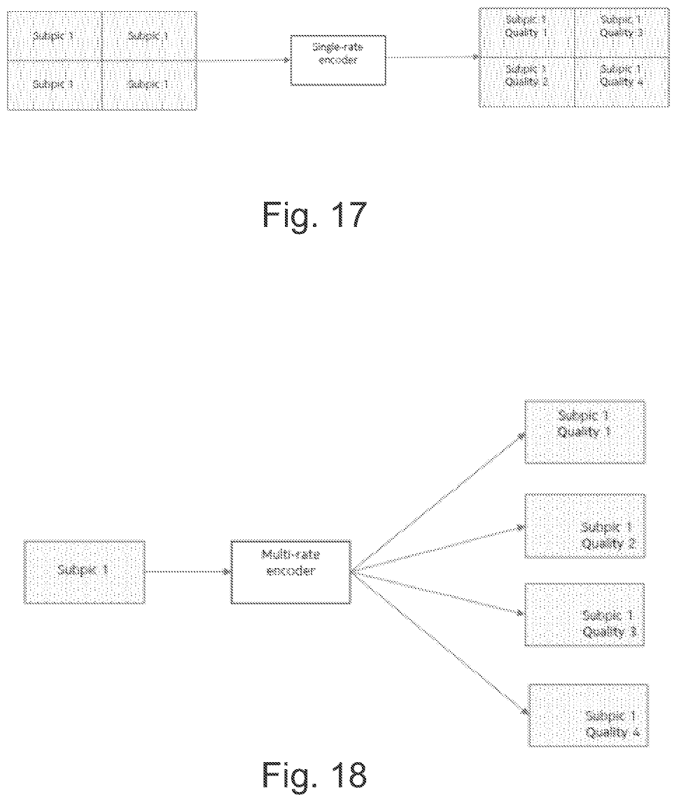

As shown in FIG. 17, the subpicture versions maybe packed into a single picture and coded in different versions using a single-rate encoder. A single-rate encoder may be defined as an encoder that creates a single bitstream from a single input picture sequence in a manner that different subpictures within the bitstream may have different qualities or bitrates with respect to each other. Alternatively, each subpicture version maybe encoded using a multi-rate encoder as illustrated in FIG. 18. A multi-rate encoder may be defined as an encoder that creates multiple bitstreams from a single input picture sequence in a manner that each bitstream may have different quality or bitrate.

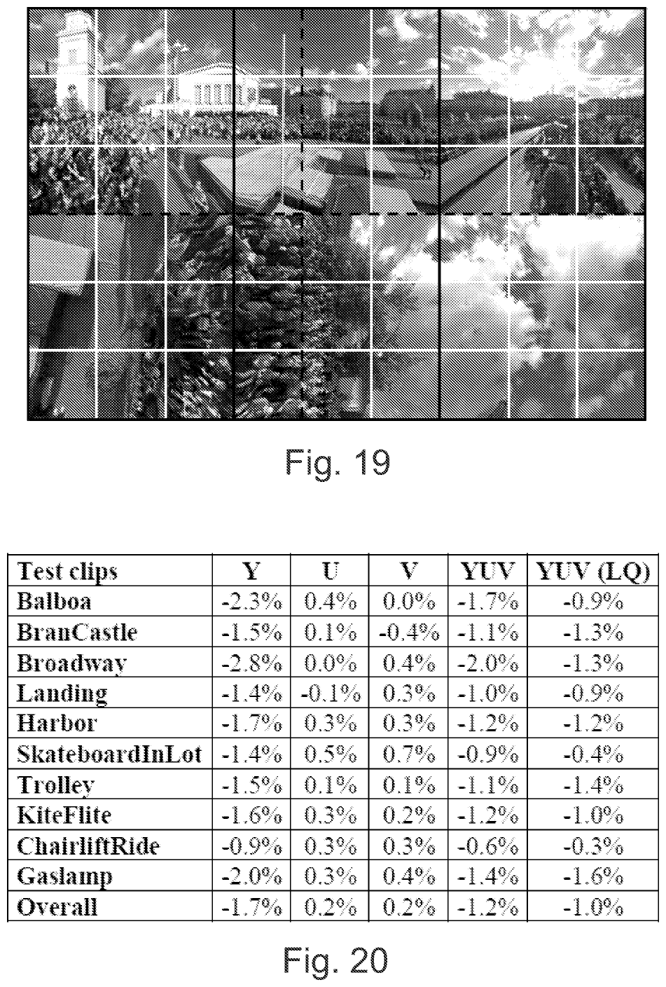

In order to demonstrate the Bjontegaard Delta (BD)-rate gain of an ALF APS allocation strategy, an exemplary subpicture-group partitioning of a VR content in cubemap projection (CMP) format is illustrated in FIG. 19 where the solid black lines are the CMP boundaries, solid white lines are individual subpictures boundaries, and black dashed lines are ALF-APS subpicture-group boundaries. Each picture is divided into 4 subpicture groups, where 1 ALF APS with a unique identifier in the range of [0 . . . 7] is allocated for each group. Here, a two-version mix-quality VAS is considered. For each version a set of 4 ALF APS is allocated. FIG. 20 shows the sequence-wise and average BD-rate gain of this allocation plan, when compared with the case in which ALF APS is disabled.

The embodiments relating to the encoding aspects may be implemented in an apparatus comprising means for dividing pictures of one or more input picture sequences into a plurality of subpictures; means for encoding each of the subpictures into a plurality of subpicture versions having different quality and/or resolution; means for partitioning the plurality of subpicture versions into one or more subpicture groups; and means for allocating a range of adaptive loop filter parameter set identifiers for each of said subpicture groups.

The embodiments relating to the encoding aspects may likewise be implemented in an apparatus comprising at least one processor and at least one memory, said at least one memory stored with computer program code thereon, the at least one memory and the computer program code configured to, with the at least one processor, cause the apparatus at least to perform: divide pictures of one or more input picture sequences into a plurality of subpictures; encode each of the subpictures into a plurality of subpicture versions having different quality and/or resolution; partition the plurality of subpicture versions into one or more subpicture groups; and allocate a range of adaptive loop filter parameter set identifiers for each of said subpicture groups.

Such apparatuses may comprise e.g. the functional units disclosed in any of the FIGS. 1, 2, 3a, 3b 5, 6a and 6b for implementing the embodiments.

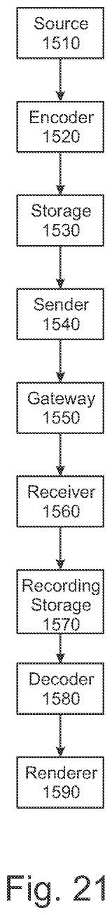

FIG. 21 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be decoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random access memory. The format of the coded media bitstream in the recording storage 1570 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1570 is discussed to simplify the description without a lack of generality

The coded media bitstream may be processed further by a decoder 1570, whose output is one or more uncompressed media streams. Finally, a renderer 1590 may reproduce the uncompressed media streams with a loudspeaker or a display, for example. The receiver 1560, recording storage 1570, decoder 1570, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

A decoder 1580 may be configured to perform switching between different representations e.g. for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with concepts applying to a single picture, such as subpicture. It needs to be understood that embodiments similarly apply to respective concepts applying to a picture sequence. For example, embodiments referring to a subpicture similarly apply to a subpicture sequence.

In the above, some embodiments have been described with concepts applying to a picture sequence or video, such as subpicture sequence. It needs to be understood that embodiments similarly apply to respective concepts applying to a single picture. For example, embodiments referring to a subpicture sequence similarly apply to a subpicture.

In the above, some embodiments have been described with reference to subpicture-based viewport-adaptive streaming. It needs to be understood that embodiments may similarly be realized for any use case where bitstreams are merged as coded subpicture sequences into a destination bitstream.

In the above, embodiments have been described with reference to adaptive loop filter parameter set identifiers or ALF APS identifiers. It needs to be understood that embodiments may similarly be realized with any other identifiers that have a pre-defined or limited value range and identify parameter sets or similar syntax structures whose content may be determined as a part of encoding.

In the above, some embodiments have been described with reference to and/or using terminology of VVC. It needs to be understood that embodiments may be similarly realized with any video encoder and/or video decoder with respective terms of other codecs, such as HEVC or H.264/AVC.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe embodiments of the invention operating within a codec within an electronic device, it would be appreciated that the invention as defined in the claims may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-15. (canceled)

16. An apparatus comprising at least one processor; and
at least one non-transitory memory including computer program code;
the at least one non-transitory memory and the computer program code configured to, with the at least one processor, cause the apparatus at least to perform:
dividing pictures of one or more input picture sequences into a plurality of subpictures;
encoding each of the plurality subpictures into a plurality of subpicture versions comprising different quality and/or resolution;
partitioning the plurality of subpicture versions into one or more subpicture groups; and
allocating a range of adaptive loop filter parameter set identifiers for each of the one or more subpicture groups.

17. The apparatus according to claim 16, wherein the apparatus is further caused to perform:
partitioning the plurality of subpicture versions into one subpicture group; and
dividing the range of adaptive loop filter parameter set identifiers for each subpicture version such that the each subpicture version comprises a unique range of adaptive loop filter parameter set identifiers.

18. The apparatus according to claim 16, wherein the apparatus is further caused to perform:
partitioning the plurality of subpicture versions into a corresponding number of subpicture groups, each comprising one subpicture version; and
allocating each subpicture version a unique range of adaptive loop filter parameter set identifiers.

19. The apparatus according to claim 16, wherein the apparatus is further caused to perform:
partitioning the plurality of subpicture versions into at least one subpicture group comprising the plurality of subpicture versions; and
allocating each subpicture group a unique range of adaptive loop filter parameter set identifiers.

20. The apparatus according to claim 16, wherein the apparatus is further caused to perform:
determining a total number of allocated adaptive loop filter parameter set identifiers for the one or more subpicture groups such that a number of adaptive loop filter parameter set identifiers in any bitstream merged from the one or more subpicture groups is less than or equal to a maximum number of adaptive loop filter parameter set identifiers.

21. The apparatus according to claim 16, wherein the apparatus is further caused to perform:
determining the one or more subpicture groups obtaining an improvement on a coding rate distortion (RD) performance via usage of adaptive loop filter parameter set identifiers; and
determining a higher number of adaptive loop filter parameter set identifiers to be allocated to said one or more subpicture groups.

22. The apparatus according claim 16, wherein the apparatus is further caused to perform:
grouping co-located subpictures versions across different quality versions into one subpicture group.

23. The apparatus according to claim 16, wherein the apparatus is further caused to perform:
allocating one or more same adaptive loop filter parameter set identifiers to a plurality of the one or more subpicture groups, wherein subpicture groups with the same adaptive loop filter parameter set identifiers values but different adaptive loop filter parameter set content are configured not to be merged into a same bitstream in response to occurrence of one or more predetermined merging constraints.

24. The apparatus according to claim 23, wherein the one or more predetermined merging constraints comprise one or more of the following:
a maximum number of spherically adjacent subpicture groups that are covered by high-resolution and/or high-quality subpicture groups; or
a predetermined viewing orientation range.

25. The apparatus according to claim 16, wherein the apparatus is further caused to perform:
providing a control signal to control more than one video encoder or more than one video encoder instance, the control signal comprising said range of adaptive loop filter parameter set identifiers that are allowed to be used in encoding.

26. The apparatus according to claim 25, wherein the apparatus is further caused to perform:
formatting the control signal as one or more optional media parameters.

27. The apparatus according to claim 25, wherein the control signal is, or is a part of, a configuration file defining encoding settings used by an encoder.

28. The apparatus according to claim 25, wherein the control signal is, or is a part of, an application programming interface used to control an encoder.

29. A method comprising:
dividing pictures of one or more input picture sequences into a plurality of subpictures;
encoding each of the plurality of subpictures into a plurality of subpicture versions comprising different quality and/or resolution;
partitioning the plurality of subpicture versions into one or more subpicture groups; and
allocating a range of adaptive loop filter parameter set identifiers for each of the one or more subpicture groups.

30. The method according to claim 29, further comprising:
partitioning the plurality of subpicture versions into one subpicture group; and
dividing said the of adaptive loop filter parameter set identifiers for each subpicture version such that the each subpicture version comprising a unique range of adaptive loop filter parameter set identifiers.

31. The method according to claim 14, further comprising:
partitioning the plurality of subpicture versions into a corresponding number of subpicture groups, each comprising one subpicture version; and
allocating each subpicture version a range of adaptive loop filter parameter set identifiers.

32. The method according to claim 29, further comprising:
partitioning the plurality of subpicture versions into at least one subpicture group comprising the plurality of subpicture versions; and
allocating each subpicture group a unique range of adaptive loop filter parameter set identifiers.

33. The method according to claim 29, further comprising:
determining a total number of allocated adaptive loop filter parameter set identifiers for the one or more subpicture groups such that a number of adaptive loop filter parameter set identifiers in any bitstream merged from the one or more subpicture groups is less than or equal to a maximum number of adaptive loop filter parameter set identifiers.

34. The method according to claim 29, further comprising:
determining the one or more subpicture groups obtaining an improvement on a coding rate distortion (RD) performance via usage of adaptive loop filter parameter set identifiers; and
determining a higher number of adaptive loop filter parameter set identifiers to be allocated to said one or more subpicture groups.

35. The method according claim 29, further comprising:
grouping co-located subpictures versions across different quality versions into one subpicture group.
